(19) United States
(12) Patent Application Publication
(10) Pub. No.: US 2012/0214707 A1
(43) Pub. Date: Aug. 23, 2012

(54) METHOD FOR DETECTION OF AN ANALYTE IN A FLUID SAMPLE

(75) Inventors: Aurel Ymeti, Enschede (NL); Paulus Hendricus Johannes Nederkoorn, Enschede (NL); Alma Dudia, Enschede (NL); Johannes Sake Kanger, Hengelo (NL); Vinod Subramaniam, Enschede (NL)

(73) Assignee: Ostendum Holding B.V., Enschede (NL)

(21) Appl. No.: 13/505,429

(22) PCT Filed: Nov. 2, 2010
(86) PCT No.: PCT/NL2010/050731

§ 371 Date: May 1, 2012

(30) Foreign Application Priority Data
Nov. 2, 2009 (NL) 2003743

(51) Int. Cl. C40B 30/04; C40B 40/04

(52) U.S. Cl. 506/9; 506/15

(57) ABSTRACT

A method for detecting an analyte in a fluid sample is disclosed. The method comprises: a) providing a measurement region and a reference region, the measurement region being provided with a receptor for binding the analyte; b) providing at least one light beam so as to travel along the measurement region and along the reference region; c) providing the fluid sample into at least the measurement region; d) detecting by means of a detector an optical pattern provided by the at least one light beam after having travelled along the measurement region and the reference region; and e) deriving a presence of the analyte in the fluid sample from the detected optical pattern, wherein prior to c) a blocking fluid is provided along the measurement region and along the reference region.

The invention relates to a method and measurement system for detection of an analyte in a fluid sample. Furthermore, the invention relates to a disposable measurement structure.

There is an increasing need for highly sensitive methods, which are required to detect various types of analytes such as micro-organisms, proteins, DNA molecules, etc., and to measure their concentration in a given fluid sample solution such as sample liquid, e.g. body fluid, milk, drinking or waste water, etc., vapour or gaseous sample. In the last couple of years, the use of the sensors in medical diagnostics, food and water safety, security applications, animal and plant health monitoring, environmental monitoring, etc., is becoming increasingly important. In a sensor device, the receptor layer, e.g. an antibody layer, which is immobilized on the sensor surface, is an important component that selectively binds to/interacts with the specific analyte that is present in a given sample solution. The role of the receptor layer becomes especially important when the specific analyte needs to be detected in samples such as serum, blood, milk, etc., where other non-specific components, e.g. proteins and DNA molecules, are present as well. In recent years different coating procedures have been developed to provide/improve the specificity of receptor-analyte interactions, e.g. by preventing and/or reducing the non-specific interactions. In clinical and food applications, usually complex samples such as serum, blood, milk, etc., in which the concentration of non-specific components is much higher than the concentration of the specific analytes, need to be analyzed. An example could be detection of very low concentrations of biomarkers in blood or other relevant body fluids that could lead to early disease detection diagnosis and prevention/treatment. The presence of a high background in clinical samples can result in deterioration of the specificity of these sensors. A lower specificity implies further a decrease of the accuracy and sensitivity of the sensor.

The invention intends to improve an analyte detection.

In order to achieve this goal, the method according to the invention comprises:

a) providing a measurement region and a reference region, the measurement region being provided with a receptor for binding the analyte;

b) providing at least one light beam so as to travel along the measurement region and along the reference region;

c) providing the fluid sample into at least the measurement region;

d) detecting by means of a detector an optical pattern provided by the at least one light beam after having travelled along the measurement region and the reference region; and

e) deriving a presence of the analyte in the fluid sample from the detected optical pattern.

The optical light beam travels across the measurement and reference regions in various ways. It is for example possible that the beam is split up by a divider or other splitter in a measurement beam and a reference beam, respectively travelling across the measurement region and the reference region. Alternatively, it is possible that the measurement and reference regions together form a waveguide structure which allows passage of the beam in two or more propagation modes. The measurement and reference regions may thereby be assigned to respective parts of the waveguide structure, examples of which will be provided below. The optical radiation from the measurement and reference regions may then interact with each other, e.g. by means of interference, resulting in a pattern, such as an interference pattern, on a surface of the detector. As a result of binding of an analyte (e.g. a molecule, assembly of molecules, or molecule group, virus, bacteria, cell, etc) on the sensor surface of the measurement region which is coated with a receptor layer, an optical behavior of the respective region will be altered, which results in a change in a property (e.g. a phase change) of the light beam or light beam propagation mode from the respective region. As a result thereof, the interference pattern will show a change, the resulting pattern being detected by the detector and analyzed. The presence (e.g. a concentration, a change of concentration, an occurrence, binding kinetics, affinity to the receptor, etc.) of the analyte may be derived therefrom.

The deriving a presence of the analyte in the fluid sample from the detected optical pattern may comprise measuring a differential signal between the measurement and reference regions. By measuring a differential signal, similar effects occurring in both measurement and reference regions will substantially compensate each other. At the detector, an optical pattern results such as an interference pattern from an interference between the beam having travelled along the measurement region and the beam having travelled along the reference region. The interference pattern is detected by the detector and processed, such as by performing a Fourier transform (e.g. a fast Fourier transform FFT) on the detected interference pattern. A value (such as a single value) may be derived from the processed data. For example, from the Fourier transformed interference pattern, a spatial frequency peak is selected that relates to the interference between the two regions in question, and a phase of the selected spatial frequency peak is represented by a single value. In case a plurality of regions are used, for each relevant pair of regions, a spatial frequency peak is selected that represents an interference between that pair of regions. The phase value corresponding to each pair of channels is extracted at the phase part of the FFT at the given spatial frequencies.

Non-specific binding, which may stem from binding to a.o. non-specific binding sites of the receptor and/or from non-specific binding to sensor surface, usually occurs simultaneously with the specific binding, resulting also in a change in the optical behavior of the measurement region, thereby resulting in an additional change of the detected pattern, which reduces the specificity of the measurement.

In order to improve a specificity of the measurement, prior to c) a blocking fluid may be provided along the measurement region and along the reference region. The blocking fluid may for example comprise components which provide for a non-specific binding in the measurement region, preferably without significantly changing a capability of the receptor layer to bind the analyte, and the reference region, examples of the blocking fluid including e.g. a serum that does not contain the analyte, or any other fluid containing a component that provides for a non-specific binding but that does not contain the analyte. In this embodiment, the reference channel may but does not necessarily need to be provided with the sample. Instead, the fluid sample can be provided in the measurement region only. Thereby, a reference fluid (such as a serum, other examples provided elsewhere in this document) may be applied in the reference channel. For clarification reasons, more specific examples of the blocking fluid include, but are not limited to, a fluid comprising Protein A, Bovine Serum Albumine (BSA), casein, or gelatine or a combination of these. Under ideal conditions the blocking fluid would also include a non-specific receptor, which e.g. can be an antibody non-specific to the analyte of interest or an oligo (DNA/RNA) molecule/string not specific to the analyte of interest or an enzyme not specific to the analyte of interest. Such to mimic the circumstances for non-specific blocking in the reference and the measurement regions as closely as possible. Ideally the only difference would be the presence of the specific binding site in the measurement region. In other words: both the reference and measurement regions may initially be coated by the blocking fluid, e.g. with abundant Protein A comprised in the blocking fluid, to reduce the non-specific binding to the sensor surface of as well the measurement region as the reference region. The blocking fluid may thereby saturate e.g. a bulk of the non-specific binding sites at the receptor (present in the measurement region only) and/or generally at the sensor surface in the measurement region and/or the reference region. By the application of such a blocking fluid, both the measurement and reference regions are initially coated with non-specific components, the providing of the fluid possibly containing the analyte to be detected may mostly result in specific binding only, as non-specific binding has already taken place to a substantial extent by the application of the blocking fluid. The blocking fluid may be applied before or after the receptor has been provided in the measurement region. If for example the blocking fluid comprises Protein A, providing the blocking fluid in the measurement region before the provision of the receptor, may result in an improved orientation and anchoring of the receptor in the measurement region. However, in case the blocking fluid is applied after having provided the receptor in the measurement region, non-specific binding sites on the receptor itself may be saturated by the blocking fluid so as to keep open substantially only the specific binding sites of the receptor in the measurement channel.

Furthermore, it is also possible to provide a modified receptor in the reference region, the modified receptor being modified in that its specific binding capabilities for binding the analyte are removed. Thereby, a similarity between the measurement region and reference region may be further improved so as to further reduce effects of the non-specific binding on the measurement results.

The light beam may comprise any suitable beam, e.g. a substantially coherent beam, a substantially monochromatic beam, multiple wavelengths beam, or a beam having a spectrum substantially continuously extending over a wavelength range (such as white light or other super continuum) etc. The beam may be in any suitable wavelength range, e.g. visible or near infrared, infrared, ultraviolet, and may be generated by any suitable optical source, such as a laser, a semiconductor laser diode, a superluminescent diode, a VCSEL (vertical-activity surface-emitting laser), a light emitting diode equipped with suitable filters such as polarizing filters, etc. The detector may comprise a CCD (charge coupled device) or other suitable camera such as CMOS (complementary metal-oxide-semiconductor), and may be formed by e.g. a line array or two dimensional pixel array. The processing of the detected pattern may be performed by any suitable processing device (e.g. a microcontroller, microprocessor, embedded controller, personal computer, single board computer, personal digital assistant, etc) provided with suitable software, or by suitable dedicated electronics. The processing may be performed in real time during the image capturing, allowing e.g. performance of a real-time kinetics measurement or in-line production analysis, or at a later moment in time. An example of a suitable processing is described e.g. in S. Nakadate (1988) J. Opt. Soc. Am. A 5, 1258-1264.

The white light or super continuum may provide for more (accurate) information to be obtained in a nanometer domain of the analysis, e.g. at nanometer distance of the sensing surface. Other light beams may e.g. be more suitable for obtaining information at larger distances from the sensing window.

In accordance with an embodiment of the invention, the effects of non-specific binding on the measurement results may be reduced, as—due to the fact that the sample fluid is brought to the measurement region (e.g. measurement channel) as well as to the reference region (e.g. reference channel), non-specific binding will occur on both channels—as opposed to the known configurations wherein the specific as well as the non-specific binding both take place in the measurement region only. As a result of the occurrence of the non-specific binding in the measurement region as well as in the reference region, the effects thereof on the pattern as detected by the detector, may at least partly compensate each other, as a differential signal between the measurement region and the reference region may be largely due to the effects of the specific binding. As a result, a lower sensitivity towards non-specific binding may occur, hence improving the sensitivity of the measurement.

In case the blocking fluid is brought into the measurement and reference regions (e.g. channels) and the fluid sample is brought into the measurement and reference regions, a highly accurate measurement may be provided. By coating not only the measurement region with the blocking fluid, but also the reference region, a similar non-specific layer due to the binding of the blocking fluid components to the non-specific binding sites on the sensor surface will be immobilized on both the measurement region and the reference region. In this case, the disturbing factors that may be present during a binding event occurring in the measurement region, e.g. temperature changes, etc., may be better compensated between the measurement region and the reference region because the (optical) layer structure of the reference region becomes as close as possible similar to the (optical) layer structure of the measurement region. As such, the signal caused by the temperature changes in the reference region may be closer to the signal caused by the temperature changes in the measurement region, as compared to the situation when no blocking fluid is used in the reference region. Therefore, the compensation/cancellation of the signal due to the temperature changes may be more effective when blocking fluid is provided not only on the measurement region, but also in the reference region. This may result in a more stable differential signal measured for the specific binding when both the measurement region and the reference region are provided with the blocking fluid compared to the situation when only the measurement region is provided with the blocking fluid.

Another disturbing factor that could influence the stability of the sensor signal measured for the specific binding is the desorption/detachment of the components, e.g. of the blocking fluid, which may be weakly bound, from the sensor surface of the measurement region, but also from the antibody layer. This factor may become relevant especially when a flow system is used for coating of the sensor surface and application of the analyte sample, as it occurs in the interferometric based devices mentioned above. Providing the reference region with the blocking fluid may result in a comparable signal due to desorption/detachment of the blocking fluid components from the sensor surface of the reference region, which may largely compensate/cancel a signal due to desorption/detachment of the blocking fluid components from the sensor surface of the measurement region, resulting in a more stable differential signal corresponding to the specific binding.

In an embodiment, after having applied the blocking fluid to both the measurement and reference region, the sample fluid is applied to both the measurement region and the reference region. If the sample fluid will be provided not only into the measurement channel, but also into the reference channel, which both were previously coated with the blocking fluid, then next to a more stable differential signal, as illustrated above, a reduction/compensation of a bulk effect between the sample fluid and the blocking fluid may be provided. This may result in a more accurate measurement, for example an accurate estimation of an initial slope of a binding curve, which is used to derive the presence of the analyte during the very first minutes after application of the sample fluid. The term bulk effect is defined as the signal (i.e. the difference in the interference pattern) that results when instead of a same fluid in the measurement and reference region, a fluid is applied into the measurement region and a different fluid is applied into the reference region, e.g. blocking fluid and sample fluid. Furthermore, when the sample fluid is provided into both the measurement region and the reference region, the additional non-specific binding that may be caused by sample fluid components other than specific analyte will be compensated between the measurement region and the reference region, contributing therefore to a more accurate differential signal corresponding to the specific binding. In case the blocking fluid is applied after having provided the receptor in the measurement region, non-specific binding sites on the receptor itself may be saturated by the blocking fluid so as to keep open substantially only the specific binding sites of the receptor in the measurement channel.

In an embodiment, a differential measurement is performed. As explained above, an interference pattern is obtained from the light beam having travelled along the measurement region and along the reference region. By measuring a differential signal, similar effects occurring in both measurement and reference region will substantially compensate each other. In a further embodiment, a change over time of the differential signal is measured, thereby measuring. the changes over time in the interference pattern: in other words, in an embodiment, the optical pattern is detected in accordance with d) before and after providing the sample fluid in the measurement and/or reference regions, and e) comprises deriving a presence of the analyte in the fluid sample from a change in the detected optical pattern before and after providing the sample fluid in the measurement and/or reference regions. As similar effects in the measurement and reference region substantially compensate each other, and as in a preferred embodiment the blocking fluid is brought into both the measurement and the reference region, and the sample fluid is also brought in both the measurement and the reference region, similar conditions are provided in the measurement and reference regions, and as a result any changes observed in the interference pattern—should (almost) entirely be due to the (built up) presence of analyte of interest in the measurement region. Whereas the analyte of interest does not specifically bind in the reference region, and whereas the presence of the specifically bound analyte in the measurement region causes a phase change in the measurement region which does not occur in the reference region, this difference in phase change between the measurement and the reference region causes a change in the interference pattern, which can be analyzed over time and which change has a direct relationship with the concentration of the analyte of interest in the measurement region. As a result of the similar conditions in the measurement and reference regions (in particular when the blocking fluid is brought in the measurement and reference region and the sample fluid is brought in the measurement and reference region as well), disturbing factors will compensate each other to a large extent, so that a change in the interference pattern will result almost entirely from a buildup of the analyte in the measurement region. An aim of the underlying method is thus to impose a difference in the optical behaviour between the measurement and the reference region, whereby this difference should ideally be entirely due to specific binding of the analyte of interest in the measurement region.

In somewhat more general wording, the above principle may be described as follows: In an embodiment of the invention, the method further comprises detecting before c) by means of the detector a reference optical pattern provided by the at least one light beam after having travelled along the measurement region and the reference region,

wherein d) is performed at least once during or after providing of the fluid sample into at least the measurement region,

and wherein e) comprises:

comparing a characteristic of the reference optical pattern with the characteristic of the optical pattern detected in d), and obtaining the presence of the analyte therefrom.

Whereas the analyte of interest does not specifically bind in the reference region, and whereas the presence of the specifically bound analyte in the measurement region causes a phase change in the measurement region which does not occur in the reference region, this difference in phase change between the measurement and the reference region causes a change in the optical pattern (for example the interference pattern), which can be analyzed over time and compared to the (reference) optical pattern obtained before applying the fluid sample, and which change may have a direct relationship with the concentration of the analyte of interest in the measurement region. As a result of the relatively similar conditions in the measurement and reference regions (in particular but not exclusively when the blocking fluid is brought in the measurement and reference region and the sample fluid is brought in the measurement and reference region as well), disturbing factors will compensate each other to a large extent, so that a change in the interference pattern will result almost entirely from a buildup of the analyte in the measurement region. The further effects as described in the above paragraph may apply to this embodiment likewise. It is noted that the reference optical pattern may in this document also be referred to as the optical pattern or the interference pattern detected before application of the fluid sample into the measurement region (and possibly the reference region) or any other similar wording. The term reference optical pattern is thus to be understood as an optical pattern detected before the providing of the sample fluid in c).

In order to achieve accurate results while analyzing the patterns quickly, in an embodiment, the characteristic of the optical pattern and the reference optical pattern comprises a phase of a frequency component in a spatial frequency spectrum (e.g. obtained by means of a fast fourier transform) of the optical pattern, the frequency component from an interference between the at least one light beam having travelled along the measurement region and having travelled along the reference region.

Another disturbing factor that often limits the sensitivity in a sensor device is the presence of drift, e.g. due to temperature changes that occur e.g. when sample solutions that need to be analyzed are brought to the sensor surface. Drift can also be caused by temperature changes of the environment, heat exchange during a binding event, etc. Because the signal due to the drift occurs simultaneously with the signal due to the specific binding, during the time frame of a binding event it is practically impossible to discriminate between specific binding signals and drift signal. This may cause a further decrease of the specificity and sensitivity of the sensor.

In a further embodiment of the method, a second reference region is provided,

wherein d) further comprises measuring a deviation between the reference region and the second reference region, and

wherein e) further comprises estimating a disturbance from the deviation measured in d) between the reference region and the second reference region, and correcting the information concerning the presence of the analyte for the estimated disturbance.

Making use of this concept, disturbances, such as a drift (e.g. due to temperature effects), an effect of non-specific binding, or other effects may be at least partially be corrected for by using the measurement between the reference region and the second reference region to obtain information that may be applied to correct for this disturbance.

As an example, an effect of drift may at least partially be compensated by measuring a drift between the reference region and the second reference region, estimating the drift between the measurement region and the reference region from the measured drift between the reference region and the second reference region.

In order to provide an accurate estimation, before provision of the fluid sample, i.e. before c), a first drift may be measured between the measurement region and the reference region, and a second drift may be measured between the reference region and the second reference region. Thereby, a drift relation can be determined between the first and second drifts. These drift measurements may be performed with a reference fluid in one or more of the regions, preferably in each one of the regions, so as to obtain similar conditions in each of the regions. Hereby, the reference fluid can actually be chosen to mimic the sample fluid as closely as possible, such to ideally have the only difference between the reference fluid and the sample fluid stemming from the potential presence of the analyte in the sample fluid. After having performed the drift measurements, the sample is provided in at least the measurement region. A measurement of the measurement region in respect of the reference region is performed. Furthermore, a measurement of the reference region in respect of the second reference region is performed. A drift that occurs during the measurement between the measurement region and the reference region may now be estimated from the determined drift relation, and a measurement between the reference region and the second reference region (which expresses the drift occurring during the measurements between the reference region and the second reference region). The measurement between the measurement region and the reference region (which should ideally only express the binding of the analyte) can now be corrected for the estimated drift between these regions, which may reduce an adverse effect of drift on the measurement accuracy. In other words, the effects of drift in the specific binding signal may be reduced, as the drift signal measured between the reference region and the second reference region may be used to determine or estimate the drift that occurs between the measurement region and reference region. This could be achieved by e.g. determining the relation between measured signals for each pair of regions prior to application of the fluid sample containing the analyte. Examples of reference fluids include, but are not limited to, serum not containing the analyte, solutions containing Protein A or BSA or can even consist of pure buffer such as PBS (phosphate buffered saline). For clarification: the actual sample—possibly containing the analyte—will be introduced at the (first) reference region and the measurement region, but preferably not in the second reference region. This latter region will preferably be exposed to the reference fluid, whereby the reference fluid is brought simultaneously or sequentially to the second reference region during the time when the sample is introduced at the (first) reference region and the measurement region.

The above concept of the provision of a second reference region may be repeated by addition of a third reference region, etc so as to be able to take account of two or more disturbances. In an embodiment, a third reference region is provided, wherein d) further comprises measuring a deviation between the second reference region and the third reference region, and

wherein e) further comprises estimating a further disturbance from the deviation measured in d) between the second reference region and the third reference region, and correcting the deviation between the reference region and the second reference region for the estimated disturbance between the measurement region and the reference region.

As an example, during a measurement, the second and third reference regions are provided with a reference fluid, while the measurement region and the reference region are provided with the sample. A measurement of the deviation between the second and third reference regions provides an indication of the effect of drift. A measurement of the deviation between the (first) reference region and the second reference region provides a combination of effects of drift and effects of non-specific binding (as the sample is in the reference region only). The measurement between the measurement region and the reference region can now be corrected for an estimation of the drift (obtained from the measurement between the second and third reference channels, possibly in combination with a determined drift relation as described above) and for the effects of non-specific binding.

For clarification purposes: in such embodiments, the sample potentially containing the analyte will preferably not be introduced in reference regions two and three. These reference regions are preferably exposed to the reference fluid. The effects of drift in the specific binding signal may be reduced, as the drift signal measured between the second reference region and the third reference region may be used to determine or estimate the drift that occurs between the measurement region and the (first) reference region. Also, the contribution of a possible non-specific binding of the analyte in the (first) reference region to the specific binding signal may be reduced by correcting/reducing the drift signal between the (first) reference region and the second reference region.

This could be achieved e.g. by determining the relation between measured signals for each pair of regions prior to application of the fluid sample containing the analyte.

In a further embodiment, e) comprises determining an initial slope of a measurement curve and deriving the presence of the analyte from the determined initial slope. Thereby, the initial slope may be used to extrapolate the concentration of the analyte.

Usually, binding of the analyte to the receptor is slow, and may take up to several hours until a saturation of the binding has been achieved. Determining the initial slope of the measurement curve, such as the analyte binding curve between the measurement region and reference region (as derived from the detected pattern) may allow to derive a presence and/or concentration of the analyte there from within a relatively short time frame, such as in several minutes. Hence, saturation of the measurement curve may not be required to quickly determine the concentration of an analyte, whereas a steepness of the initial slope directly relates to the concentration. This is explained further below.

In a still further embodiment, the method comprises the further steps of:

removing at least part of the analyte from the receptor layer by a removal process, the optical pattern being detected before and after the removal. Thereby, an accuracy can be further enhanced, as a measurement is performed before and after removal of the analyte, which improves an ability to discriminate an effect of binding of the analyte from non-specific binding, drift, and other factors, as a signal change obtained due to the removal may be due to the amount of analyte particles detached by the removal process. Any suitable removal process may be applied, e.g. providing a dedicated solution, such as an HCl acidic solution or an ionic gradient solution or a solution containing a competitor molecule. In such embodiment, the reference fluid may be applied along the reference region and the removal process may further be performed along the reference region and the measurement region, e.g. simultaneously. Thereby, a possible removal of non-specific components from the measurement region during the removal process may be compensated by a removal of non-specific components from the reference region.

In another configuration of such an embodiment, it is further possible that the reference fluid is further applied along the second reference region, that the removal process is further performed along the second reference region, and that e) comprises deriving a drift between the measurement region and the reference region from a drift measured between the reference region and the second reference region, and correcting the information concerning the presence of the analyte for the derived drift between the measurement region and the reference region. Thereby, in analogy with the above described embodiment wherein a second reference region is applied, a differential signal between the reference region and the second reference region (which may be caused by temperature changes and other disturbing factors) may further be used to correct for a drift signal between the measurement region and the reference region.

In a yet further embodiment, the light beam comprises at least two spectrally distinct wavelength ranges or polarization ranges, the detection being performed for each of the wavelength or polarization ranges. The ranges may e.g. each comprise a specific wavelength and/or polarization. For different wavelengths and/or different polarizations, a different sensitivity may be obtained for various binding events, as the various components that result in binding (e.g. viruses, proteins, protein assemblies or protein groups, bacteria, cells) may have different dimensions. The different sensitivities may be applied—when using multiple wavelengths and/or polarizations, to determine an effect of different contributions (specific binding, non-specific binding, etc) from the different responses at the different wavelengths and/or polarizations. Making use of these differences in sensitivity, in an embodiment, three distinct wavelength ranges are comprised in the light beam, and e) comprises determining analyte binding, non-specific binding and bulk refractive index from the detected optical patterns for each of the wavelengths.

In an embodiment, the method further comprises:

detecting a scattering of light from the measurement and reference regions and combining the detected light scattering and/or local intensity distributions with the detected optical pattern in order to derive the presence of the analyte in step e). Thereby, additional information regarding the specific binding events in the measurement region may be obtained from the scattered signal and spatial intensity distribution, allowing a further improvement in measurement accuracy and sensitivity.

In accordance with a further embodiment of the invention, a compensation of the bulk effect may be provided. Thereto. the bulk effect between the measurement region and the reference region is measured: the sample fluid is brought into the measurement region and a reference fluid is bought into the reference region, an interference pattern between the measurement and reference regions being detected and stored in a memory (for example by storing the pattern or by storing relevant information obtained from a fast fourier transform of the interference pattern, such as a phase value of a frequency peak in the fast fourier transform spectrum). When a measurement is performed, whereby the sample is in the measurement region and the reference fluid is in the reference region, the stored information that represents the bulk effect may be applied to correct for the bulk effect, i.e. for the contribution of the different fluids to the interference pattern.

As an example: in the reference region, a PBS buffer with an RNA string (probe) is brought. In the measurement region, a sample (such as a serum) is brought that contains the RNA string (probe) and possibly a complementary string whose presence is to be detected. Antibodies are provided in the measurement and reference region. RNA strings and if present, the complementary strings, are bound to the antibodies by means of a tag. The stored value(s) that represent an effect of the different fluids in measurement and reference regions, may be applied to correct a measured interference pattern, so as to substantially remove an effect of the different fluids on the interference pattern and measurement so as to more accurately measure a contribution of binding of the analyte. In both the measurement and reference region, the RNA probes bind with the tag to the antibodies, however only in the measurement channel the complementary RNA/DNA (i.e. the analyte) binds to the probe, which probe has a tag. This tag is subsequently bound to the antibody on the chip surface.

In the above method it is also possibly that the sample fluid, such as a serum, is brought into both the measurement and reference region so as to keep the circumstances in both regions as close as possible. In that case, the probe in the reference region should be a dummy so as to avoid any binding of the analyte in the reference region. Both measurement methods may also be applied simultaneously (whereby two reference regions are required as also described below) so as to obtain more information and consequently a higher accuracy.

According to a further aspect of the invention, a measurement system is provided for detecting an analyte in a fluid sample, comprising:

a measurement region and a reference region, the measurement region being provided with a receptor for binding the analyte;

a light source for generating at least one light beam so as to travel along the measurement region and along the reference region;

a fluid supply for providing the reference fluids and for the fluid sample into the measurement region and the reference region;

a detector for detecting an optical pattern provided by the at least one beam after having travelled along the measurement region and the reference region; and

a data processing device for deriving a presence of the analyte in the fluid sample from the detected optical pattern.

With the measurement system, the same or similar advantages may be achieved as with the method according to the invention. Furthermore, the same or similar embodiments may be provided, each providing same or similar advantages as with the method according to the invention.

In an embodiment, at least the measurement region and the reference region are provided on a planar structure (also referred to as chip structure), the measurement system comprising holding means for replaceably holding the chip structure. Thereby, a versatile measurement system may be created: measurements may be performed for different analytes by making use of corresponding chip structures which are each provided with a suitable receptor for the specific analyte to be measured. A variety of samples can be analyzed with a respective chip structure by providing each of the samples on the respective chip structure and placing the chip structures (e.g. one after the other) in the measurement system. Cross contamination of samples may be prevented in that the different samples are each applied to a different chip. Different samples can also be applied to different (measurement) parts on one and the same chip.

The planar structures (also referred to as “chips”) may be in part manufactured in a semiconductor material patterning and etching process, thereby allowing to supply them at a reasonable cost. Alternatively, other (optically) suitable materials may be applied. In order to detect various analytes, different receptors may be provided on the respective measurement regions of such chips. The comparably low cost further allows one time use, thereby facilitating handling and obviating regeneration/cleaning after each measurement.

The fluid supply may be provided with a reservoir, e.g. a micro reservoir for holding a (small) amount of the fluid to be analyzed, the fluid then being provided to the measurement and/or reference region/channel by capillary force e.g. through a (micro-)fluidic system that forms part of the chip and which comprises (micro-)fluidic channels that specifically address/are coupled to one reference region/channel or one measurement region/channel, a (micro-) fluidic pump, gas pressure, etc. A fluid can also be flowed continuously over one or more specific parts of the chip. The chip can be either disposable or enable re-usage as explained below. The feature that of the measurement region and the reference region being provided on a chip structure, the measurement system comprising holding means for replaceably holding the chip structure, can not only be applied in the measurement system according to the invention, but also in any other interferometer based measurement system. Hence, such measurement system could also be described as:

a measurement system for detecting an analyte in a fluid sample, comprising:

a measurement region and a reference region, the measurement region being provided with a receptor for binding the analyte;

a light source for generating at least one light beam so as to travel along the measurement region and along the reference region;

a fluid supply for providing the fluid sample into at least the measurement region;

a detector for detecting an optical pattern provided by the at least one beam after having travelled along the measurement region and the reference region; and

a data processing device for deriving a presence of the analyte in the fluid sample from the detected optical pattern, wherein

at least the measurement region and the reference region are provided on a chip structure, the measurement system comprising holding means for replaceably holding the chip structure.

The fluid supply may also be connected to or comprised in the (replaceable) chip structure, thereby being replaceable (with the chip) at least in part, so as to e.g. prevent a next sample to be contaminated by a remainder of a previous sample in the fluid supply. The reservoir of the fluid supply may be connected to or comprised in the chip so that each chip has its own, however a separate reservoir may be provided as an alternative.

The chip structure and the fluid supply may be held by a holder and so as to align the fluid supply to at least the measurement region by the holder.

In the above and other embodiments of the present invention, a method and measurement system are provided for highly specific and sensitive analyte detection in fluid sample solutions, e.g. liquids such as body/animal/plant fluid (serum, plasma, blood, sputum, etc.), milk, drinking or waste water, etc., vapours or gasses such as air, which e.g. can be pre-treated and diluted into a liquid, e.g. PBS buffer. Analytes present in the gas sample may in this way be solved in the liquid which may thereupon be analyzed.

Gasses could also be detected using gas absorbent layers that are specific towards a given gas component, e.g. CO2, toxic gasses, etc.

Further advantages, embodiments and effects of the invention will become clear from the appended drawing and corresponding description, in which non-limiting embodiments of the invention are depicted, in which:

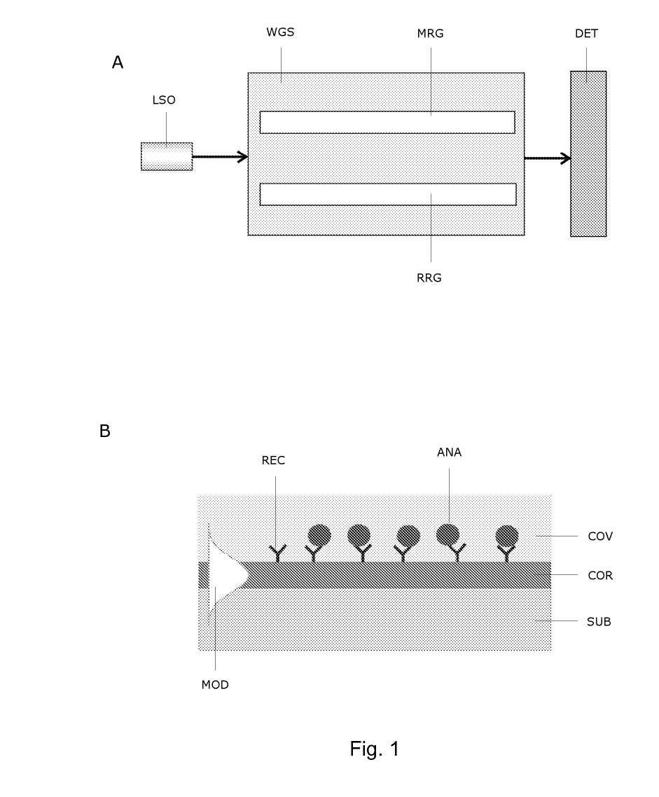

FIGS. 1A and B provide a general schematic view of an interferometric based sensor and analyte binding taking place therein;

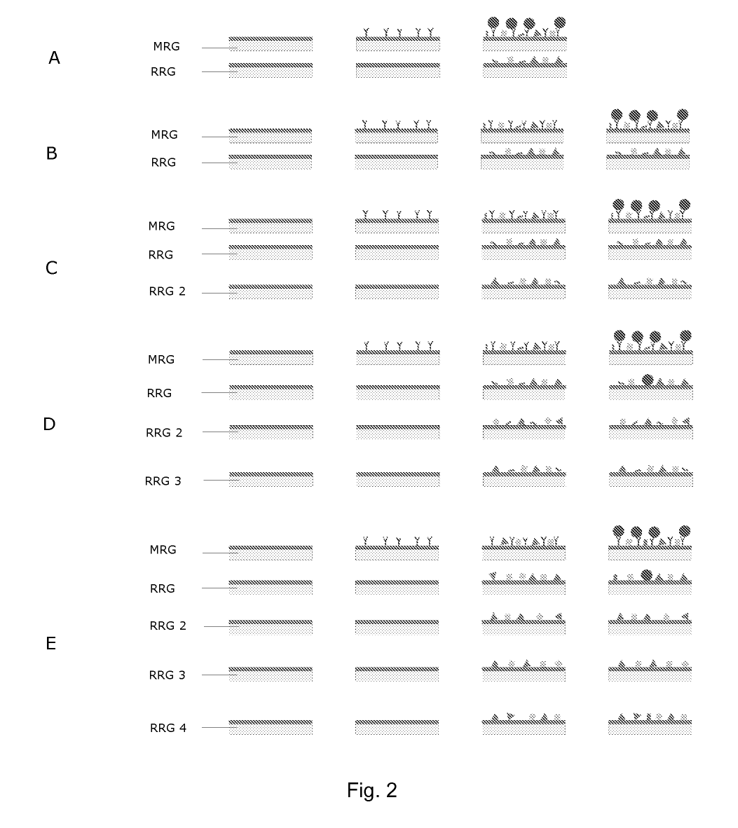

FIGS. 2A, B, C,D and E provide a schematic representation of analyte binding in different measurement schemes in order to illustrate various embodiments of the invention;

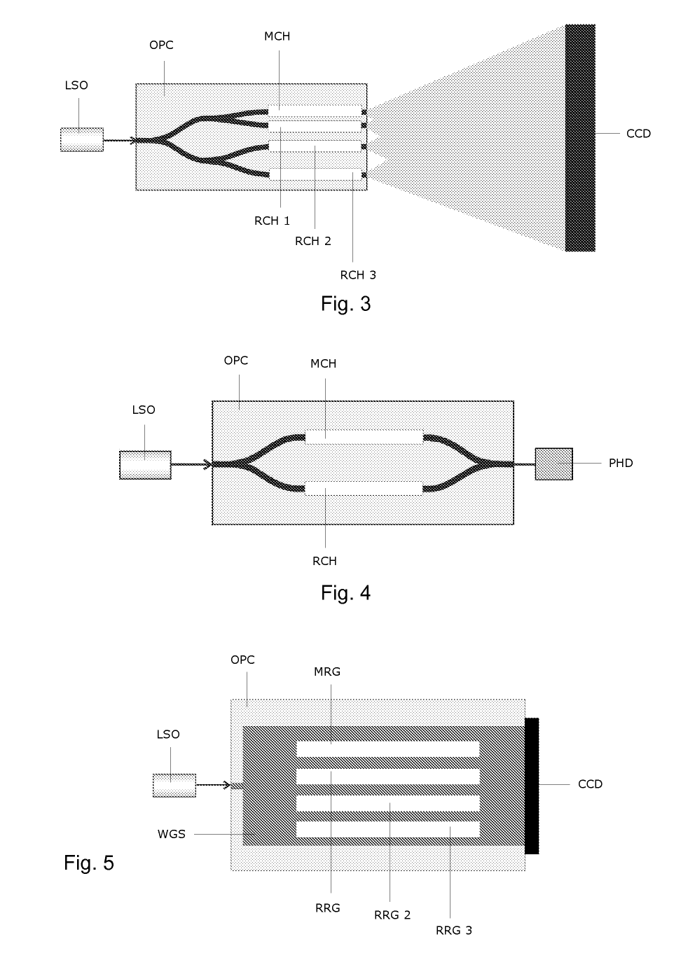

FIG. 3 provides a schematic representation of a Young interferometer based sensor in which various embodiments of the invention may be applied;

FIG. 4 provides a schematic representation of a Mach-Zehnder interferometer based sensor in which various embodiments of the invention may be applied;

FIG. 5 provides a schematic representation of a Multi-Mode interference based sensor in which various embodiments of the invention may be applied;

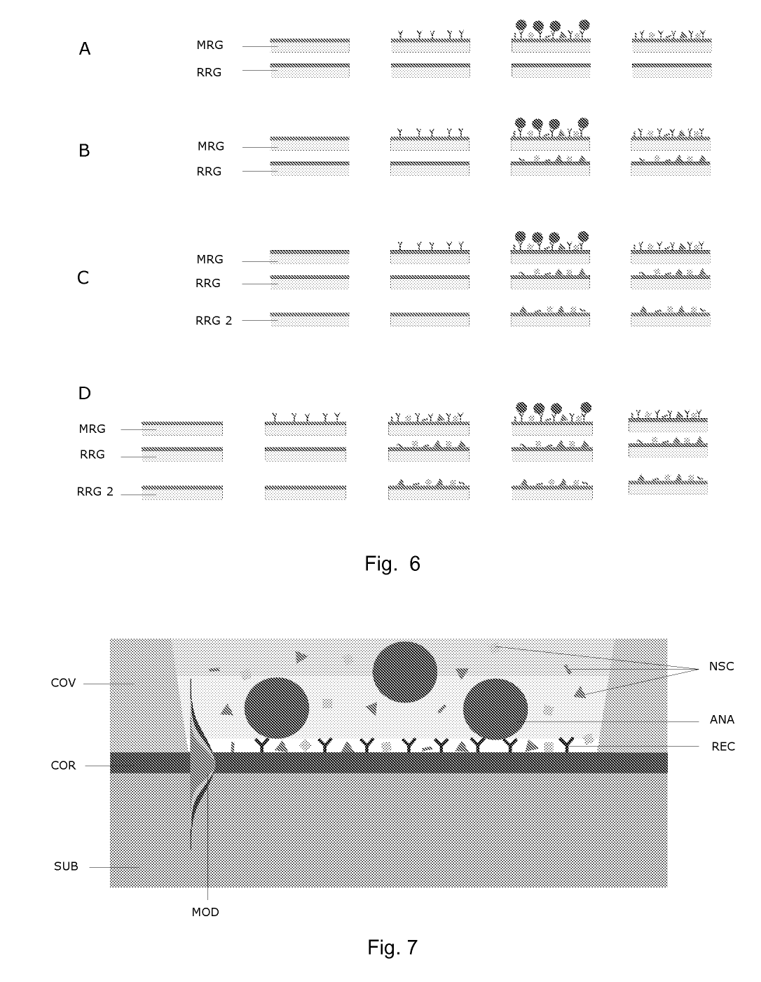

FIGS. 6A, B, C and D provide a schematic representation of analyte binding in different measurement schemes in order to illustrate various embodiments of the invention;

FIG. 7 provides a schematic representation of analyte binding to illustrate embodiments of the invention;

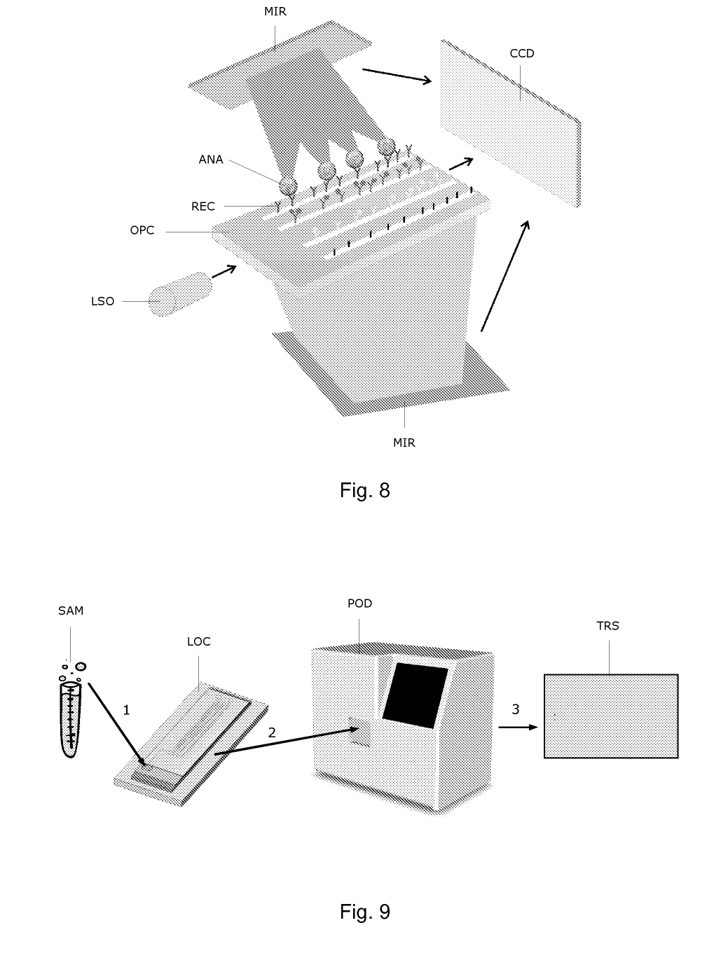

FIG. 8 provides a schematic representation of an interferometric sensing configuration in order to illustrate various embodiments of the invention;

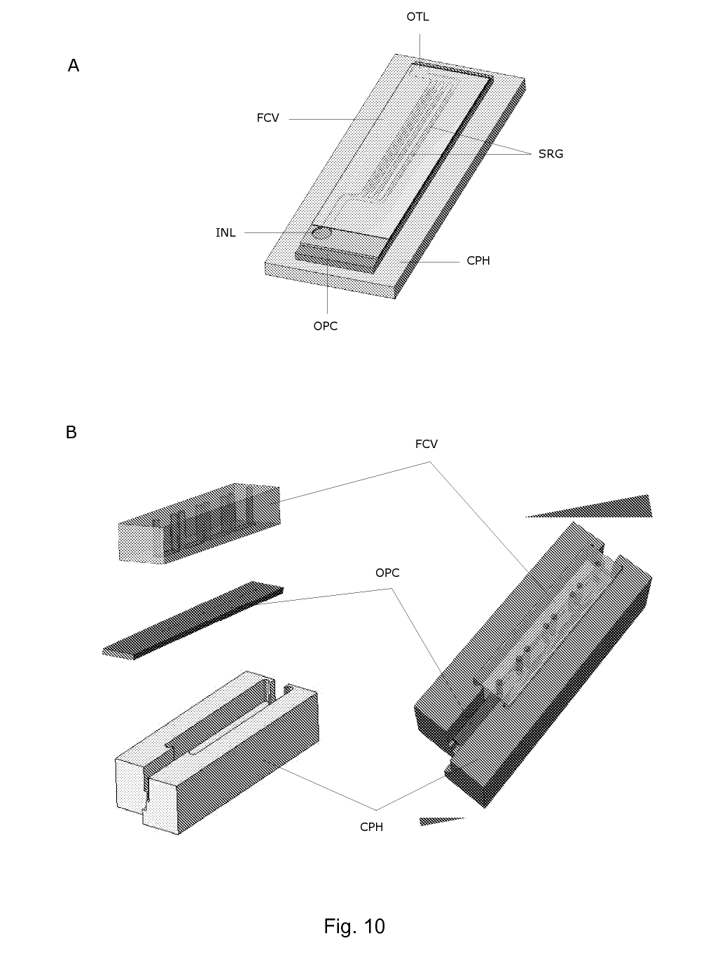

FIG. 9 provides a schematic representation of a measurement system in accordance with an embodiment of the invention; FIGS. 10A and B depicts embodiments of a lab-on-a-chip system to be applied in embodiments of the invention;

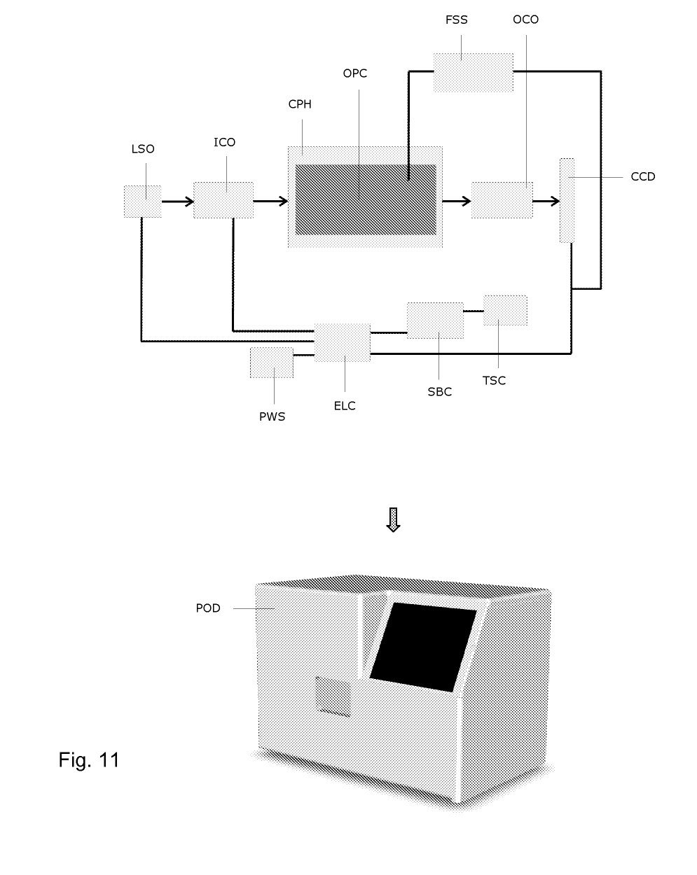

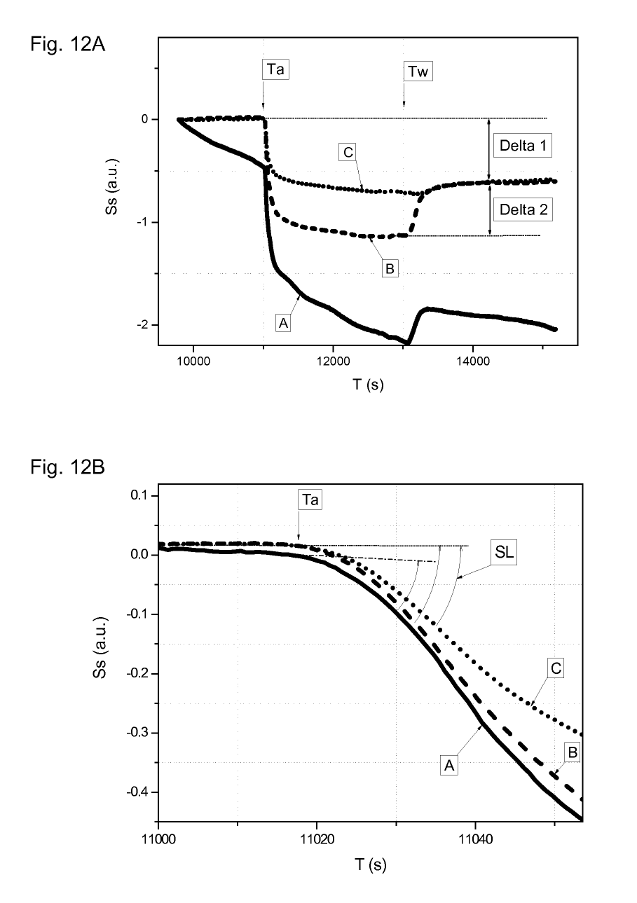

FIG. 11 provides a schematic representation of a portable detector in accordance with an embodiment of the invention and

FIGS. 12A and B depict a time diagram of a detecting of an analyte in accordance with embodiments of the invention.

### ESTIMATION/REDUCTION OF NONSPECIFIC BINDING

FIG. 1A depicts a top view of a general schematic of an interferometric based sensor. In an interferometric based sensor, light beam from a (monochromatic) light source LSO, e.g. a laser, is usually coupled to an optical (channel) waveguide structure WGS. In a waveguide structure WGS, usually consisting of three layers, i.e. substrate SUB, core COR and cover COV layer (see the side view of the waveguide structure WGS depicted in FIG. 1B), guiding of the light is performed due to appropriate refractive index contrast between the core layer and the cladding (substrate SUB and cover COV layers indicated in FIG. 1B). A higher refractive index of the core layer allows total internal reflection of the light at the core-cladding interface, in that way making possible propagation of the light through the (slab) waveguide.

On top of the waveguide structure a number of sensing regions, e.g. two, can be implemented, e.g. by locally removing the top cover layer COV; one of them can play the role of the measurement region MRG and the other one can be used as the reference region RRG. Light beams propagating through the measurement MRG and reference RRG regions interfere with each other, e.g. on a screen (in this example a surface of an optical detector DET), generating an interference pattern. Measurement region is usually coated with a receptor REC such as antibody to enable specific detection of analytes ANA that are present in a given solution that is flowed through the measurement region via a fluidic system. Referring to FIG. 1B, specific analyte ANA binding to the antibody-coated waveguide surface in the measurement region, which is probed by the evanescent field of the guided modes MOD, causes a corresponding phase change that is measured as a change in the interference pattern. Analysis of the interference pattern can yield information on the amount of the analyte bound on the measurement region. This analysis of interference pattern(s) can consist of comparing interference patterns before, during and after providing the sample that may contain the analyte(s) of interest to (specific regions of) the surface of the optical waveguide structure. Various configurations of interferometric based devices have been described e.g. in: C. Stamm et al. (1993) Sensors and Actuators B 11, 177-181; R. G. Heideman et al. (1993) Sensors and Actuators B 10, 209-217; A. Brandenburg et al. (1994) Applied Optics 33(25), 5941-5947; H. Helmers et al. (1996), Applied Optics 35(4), 676-680; A. Ymeti et al. (2003) Applied Optics 42, 5649-5660; G. H. Cross et al (2003) Biosensors and Bioelectronics 19(4), 383-390.

In a (bio-)sensor device having multiple sensing regions, the surface of one of the sensing regions can be first coated with a receptor layer (measurement region). In this document, the term receptor may be understood as a substance that specifically binds the analyte. The term analyte may refer to e.g. a chemical or biological component (such as but not limited to a micro organism, protein, peptide, DNA/RNA, or combinations thereof). In a (bio-)sensor device, the receptor layer, e.g. an antibody layer, a DNA/RNA fragment that is complementary to the specific analyte, an enzyme or other specifically analyte binding substance, which is immobilized at the sensor surface, is used to selectively bind/interact with the specific analyte particles that are present in a given sample solution that needs to be analyzed. Another example is CO2 (gas) binding at the receptor layer. The function of the receptor layer is especially important when the specific analyte needs to be detected in very complex samples such as serum, blood, milk, etc., where other non-specific components, e.g. proteins, micro-organisms (such as viruses, bacteria, yeasts etc.), DNA molecules, mineral ions, etc., are present as well. Depending on the application, configuration and other circumstances, it may be desirable that the receptor layer is stable, does not have or has minimal non-specific binding sites, can be immobilized reproducibly and has high density of active receptors.

Immobilization of the receptor layer at the measurement region can be performed using different techniques that depend on the chip material, e.g. for a chip based on Silicon (Si) one can use binding to Protein A coated sensor surface. A Protein A coated sensor surface can be used to promote the binding and enhance proper orientation of the receptor for further analyte binding. Furthermore, coating the sensor surface with Protein A may result in reduction of non-specific binding to the sensor surface. Protein A is given as an example. Other proteins or substances can exhibit the same or similar functionality as Protein A: being forming a cover layer at the Si surface, thereby reducing non-specific binding to this surface and acting as proper anchor point for the receptor such as antibodies, in order to bind and orientate the receptor in a desired way. Other techniques for immobilization of the receptor layer could be used as well, e.g. physical adsorption on the sensor surface, which is based a.o. on hydrophobic interactions and hydrogen bonds, or covalent coupling, e.g. to a silanized sensor surface.

Whereas the measurement region may be coated with a specific receptor, an additional second region—also referred to as reference region—may be coated only with Protein A or another protein or molecule that exhibits similar functionality as Protein A. This is described above as blocking fluid. The body fluid sample, e.g. serum containing a specific analyte such as a biomarker, can be applied (simultaneously) in both regions, as schematically illustrated in FIG. 2.A. Coating the sensor surface of the reference region RRG with Protein A may also contribute to the reduction of the non-specific binding, in this case of the serum components, in analogy with the measurement region MRG. Compared to the known measuring approach in which usually the sample is applied only in the measurement region and therefore it is not possible to differentiate between the sensor signal caused by the specific binding of the analyte to the receptor layer immobilized on the sensor surface and the non-specific signal caused by the binding of other components in the sample solution to the sensor surface, this scheme provides the advantageous effect that the non-specific binding occurring in the reference region, which is also reduced by coating its sensor surface with Protein A in similar way as the measurement region, can largely compensate the non-specific binding that occurs simultaneously in the measurement region. Therefore the differential signal measured between the measurement region and the reference region is largely caused by the specific binding of the analyte onto the receptor layer in the measurement region, considering a comparable non-specific binding of other components in the sample to the sensor surface in both these regions.

A further embodiment is illustrated with reference to FIG. 2B. In a further application of this measuring scheme, both measurement region MRG and reference region RRG can be first coated with the blocking fluid, e.g. to reduce non-specific binding to the sensor surface, in this case in both the measurement region and the reference region, then with ‘clean’ serum sample (serum without specific analyte to be measured) or other (post-)blocking agents/solutions, consisting of one or a combination (simultaneous or sequential) of reference fluid(s), which are used to block non-specific binding sites. Commonly used blocking agents/solutions include, but without limitation, BSA (bovine serum albumin), serum, non-fat dry milk, casein, gelatin in PBS, etc. In this way, non-specific binding on the sensor surface and/or to the non-specific binding sites of the receptor may even further be reduced. Next, the body fluid sample, e.g. serum containing specific analyte, can be applied in both regions. In this configuration, because both measurement and reference regions were initially fully coated with non-specific components being present in the ‘clean’ serum sample, addition of serum containing specific analyte may result mostly in sensor signal caused by the binding of the specific analyte to the antibody layer immobilized in the measurement region, while additional non-specific signal caused by the binding of other components in the sample is expected to be negligible or much lower than specific binding because the bulk of the non-specific binding regions/sites are already occupied/blocked. As such in this measuring scheme a lower non-specific signal, which is further compensated between the measurement region and the reference region, may therefore contribute in a more accurate signal corresponding to the specific binding.

A further embodiment is illustrated with reference to FIG. 2C. In a further measuring scheme, an additional second reference region RRG 2 pre-coated e.g. with Protein A may be further coated with ‘clean’ serum sample. Coating with Protein A here may have a similar purpose as in the case of the measurement region MRG and reference region RRG, such as to reduce the non-specific binding to the sensor surface and/or to proper orientate the receptor molecules. The additional exposure to clean serum may even further reduce any resulting non-specific binding in as well the reference and the measurement regions. The differential signal that may result between the reference region RRG and the second reference region RRG 2 is largely due to temperature differences between these regions, resulting in the so-called drift. Other factors may include drift in the alignment of the optical set-up. The temperature differences can be caused by temperature changes of the environment, e.g. draught. A difference in the temperature of the sample solutions, which are flowed in these regions, may also result in a temperature difference between them. Furthermore, a temperature difference can occur e.g. due to the binding event taking place in the measurement region where heat exchange with the surrounding may occur. Because the signal due to the drift in the measurement region occurs simultaneously with the signal due to the specific binding, during the time frame of a binding event it is practically impossible to discriminate between the signal due to specific binding and the signal due to the drift. In this measuring scheme, the drift signal measured between the reference region and the second reference region may be used to correct/estimate the drift signal that occurs simultaneously between the measurement region and the reference region in addition to the specific signal in the measurement region. This could be achieved e.g. by determining the relation between the signals for each pair of sensing regions prior to application of the sample solution containing the specific analyte. Correction/reduction of the drift signal in this measuring scheme may therefore result in a further improvement of the accuracy of the signal measured for the specific binding.

The drift correction can be applied in a (bio-)sensor device that has at least three sensing (one measurement and two reference) regions. This correction could be possible if the differential signals between the measurement region and two reference regions are acquired, e.g. simultaneously or sequentially. It is noted that the sample—possibly containing the analyte—will preferably not be brought into contact with the second reference region, whereas this sample is preferably brought into contact with the first reference region and with the measurement region(s).

A further embodiment is illustrated with reference to FIG. 2D. In a further measuring scheme, an additional third reference region, RRG 3 which is pre-coated with the blocking fluid (e.g. with Protein A), may be further coated with ‘clean’ serum sample. Coating with Protein A here has the same purpose as in the case of the measurement region, reference region and second reference region, namely to reduce the non-specific binding to the sensor surface of these regions.

The differential signal that may result between the second reference region RRG 2 and the third reference region RRG 3 is mostly due to temperature differences between these regions and other disturbing factors, resulting in the so-called drift, whereas the differential signal between the reference region and the second reference region is due to temperature differences between these regions and other disturbing factors resulting in drift signal as well as some non-specific binding of the analyte at the sensor surface of the reference region.

The differential signal that may result between the measurement region and the reference region is due to the specific binding of the analyte at the sensor surface of the measurement region, drift signal between the measurement region and the reference region as well as the non-specific binding of the analyte at the sensor surface of the reference region. Because the signal due to the drift between the measurement region and the reference region occurs simultaneously with the signal due to the specific binding in the measurement region as well as the non-specific binding of the analyte in the reference region, during the time frame of a binding event it is practically impossible to discriminate between the sensor signal due to specific binding in the measuring region, the non-specific binding of the analyte in the reference region and the signal due to the drift between the measurement region and the reference region. In this measuring scheme, the drift signal measured between the second reference region and the third reference region may be used to correct/estimate the drift signal that occurs simultaneously between the reference region and the second reference region as well as the drift signal that occurs between the measurement region and the reference region. This could be achieved e.g. by determining the relation between the signals for each pair of regions prior to application of the sample solution containing the specific analyte. By correcting/reducing the drift signal between the reference region and the second reference region, the non-specific binding of the analyte in the reference region can be estimated. Furthermore, by correcting the drift signal between the measurement region and the reference region and estimating the non-specific binding of the analyte in the reference region, this measuring scheme may result in even a further improvement of the accuracy of the signal measured for the specific binding of the analyte in the measurement region.

This scheme could be applied in a (bio-)sensor device that has at least four sensing (one measurement and three reference) regions and if the interference signals between the measurement region and three reference regions are acquired, e.g. simultaneously or sequentially.

Thus, in the above embodiment, the sample, potentially containing the analyte to be detected, will preferably not be brought into contact with the second and the third reference regions, whereas this sample will preferably be exposed to the first reference region and the measurement region(s).

In a further measuring scheme, an additional fourth reference channel, e.g. in a multichannel YI based sensor or any other interferometric configuration having at least five sensing regions/channels (one measurement and four reference regions/channels), is (pre-)coated with the blocking/reference fluid, e.g. with Protein A, having the same purpose as in the case of the measurement channel, (first) reference channel, second reference channel and third reference channel, namely to reduce the non-specific binding to the sensor surface of these channels. In the fourth reference region sample not containing the analyte can be flowed (see schematic in FIG. 2E).

The differential signal that may result between the second reference channel and the third reference channel is mostly due to temperature differences between these channels and other disturbing factors, resulting in the so-called drift, whereas the differential signal between the third reference channel and the fourth reference channel is due to temperature differences between the third reference channel and the fourth reference channel and the bulk signal between the sample (not containing the analyte) flowed in the fourth reference channel and blocking/reference fluid flowed in the third reference channel. Furthermore, the differential signal between the (first) reference channel and the second reference channel is due to temperature differences between these channels and other disturbing factors resulting in drift signal, the bulk signal between the sample (containing the analyte) flowed in the (first) reference channel and the blocking/reference fluid flowed in the third reference channel as well as some non-specific binding of the analyte at the sensor surface of the (first) reference channel. Finally, the differential signal that may result between the measurement channel and the (first) reference channel is, as in the previous measuring scheme, due to the specific binding of the analyte at the sensor surface of the measurement channel, drift signal between the measurement channel and the (first) reference channel as well as the non-specific binding of the analyte at the sensor surface of the (first) reference channel.

In this measuring scheme, the drift signal measured between the second reference channel and the third reference channel may be used to correct/estimate the drift signal that occurs (simultaneously) between the third reference channel and the fourth reference channel, (first) reference channel and the second reference channel as well as the drift signal that occurs between the measurement channel and the (first) reference channel. This could be achieved e.g. by determining the relation between the signals for each pair of channels prior to application of the sample solution containing the specific analyte. By correcting the drift between the third reference channel and the fourth reference channel, the bulk signal between the sample (not containing the analyte) flowed in the fourth reference channel and blocking/reference fluid flowed in the third reference channel can be estimated, which is comparable to the bulk signal between the sample flowed in the (first) reference channel and the blocking/reference fluid flowed in the second reference channel. Furthermore, by correcting the drift signal between the (first) reference channel and the second reference channel and the bulk signal between the sample flowed in the (first) reference channel and the blocking/reference fluid flowed in the second reference channel, the non-specific binding of the analyte in the (first) reference channel can be estimated. Finally, by correcting the drift signal between the measurement channel and the (first) reference channel and estimating the non-specific binding of the analyte in the (first) reference channel, this measuring scheme may result in even a further improvement of the accuracy of the signal measured for the specific binding of the analyte in the measurement channel. This scheme could be applied if the interference signals between the measurement channel and four reference channels can be obtained, either simultaneously or sequentially.

An alternative measuring scheme can be applied when blocking/reference fluid containing the analyte, preferably having the same concentration as in the sample solution, will be flowed in the fourth reference channel instead of the sample not containing the analyte, as described above. In this scheme similar results with the above scheme can be obtained.

In all above schemes, reference channels can be interchanged with each other, e.g. the sample solution containing the analyte can be flowed in the measurement channel and either the first, second, third or fourth reference channel.

A Young interferometer (YI) based sensor has been described in: A. Brandenburg et al. (1994) Applied Optics 33(25), 5941-5947; H. Helmers et al. (1996), Applied Optics 35(4), 676-680; A. Brandenburg (1997) Sensors and Actuators B 38-39, 266-271; A Ymeti et al. (2003) Applied Optics 42, 5649-5660; G. H. Cross et al (2003) Biosensors and Bioelectronics 19(4), 383-390. In a YI based sensor, light beam from a (e.g. monochromatic) light source LSO, e.g. a laser, is usually coupled into an input (channel) waveguide structure OPC, and is usually split. by a beam splitter such as a network of Y-junctions (as schematically illustrated in FIG. 3), MMI coupler, star coupler, etc, into at least two beams, which propagate through respective measurement channels MCH and reference channels RCH 1, RCH 2, RCH 3 of the waveguide structure, the measurement channels and reference channels forming examples of measurement regions and reference regions respectively. The output divergent beams overlap with one another and the final interference pattern can be a superposition of individual interference patterns, each of them representing the overlap of the divergent beams of a specific channel pair, which can have a unique distance between its channels, e.g. in a configuration with more than two channels. The interference pattern can be recorded by a detector, in this example provided by a CCD (charged coupled device) camera, which is placed at a given distance from the endface of the waveguide structure. The CCD is coupled to a computer system to process the data related to the detected interference pattern. The computer applies an analysis algorithm, e.g. based on a FFT (fast Fourier transformation), to this data, from which the phase information for each pair of channels can be (simultaneously or sequentially) determined.

FIG. 4 schematically depicts a Mach-Zehnder interferometer based sensor configuration. In a Mach-Zehnder interferometer (MZI) based sensor, an example of which being disclosed in E. F. Schipper et al. (1997) Sensors and Actuators B 40, 147-153, light beam from a (e.g. monochromatic) light source LSO, e.g. a laser, is split, e.g. using a Y-junction, so as to propagate into a measurement channel MCH and a reference channel RCH which form examples of a measurement region and reference region respectively, and after propagating through the waveguide structure OPC, light beams are combined, e.g. using again a Y-junction. The out-coupled light intensity is recorded by a detector, in this example a photodiode PHD.

In a sensor configuration based on a YI or MZI or any other interferometer configuration having a measurement channel and a reference channel, each output channel can be provided with a sensing window to allow application of fluid samples to be analyzed. To apply the first measuring scheme as described above, the sensing window of one of the output channels can be coated with a receptor layer such as an antibody layer using e.g. Protein A (measurement channel). A Protein A coated sensor surface can be used to promote the binding and enhance proper orientation of the receptor for further analyte binding. Furthermore, coating the sensor surface with Protein A results in reduction of non-specific binding to the sensor surface. An additional (reference) channel may be coated only with Protein A. The body fluid sample, e.g. serum containing a specific analyte, e.g. a biomarker, can be applied (simultaneously) in both measurement and reference channels (see schematic in FIG. 2.A). Coating the sensor surface of the reference channel with Protein A may also contribute to the reduction of the non-specific binding, in this case of the serum components, in analogy with the measurement channel. Compared to the used measuring approach in which usually the sample is applied only in the measurement channel, and therefore it is not possible to differentiate between the sensor signal caused by the specific binding of the analyte to the receptor layer immobilized on the sensor surface and the non-specific signal caused by the binding of other components in the sample solution to the sensor surface, this scheme provides the advantageous effect that the non-specific binding occurring in the reference channel, which is also reduced by coating its sensor surface with Protein A in similar way as the measurement channel, can largely compensate the non-specific binding that occurs (simultaneously) in the measurement channel. Therefore the differential signal between the measurement channel and the reference channel is most probably caused by the specific binding of the analyte onto the antibody layer immobilized in the measurement channel, considering a comparable non-specific binding of other components that are present in the sample in both measurement channel and reference channel.

In a further application of this measuring scheme in the YI or MZI or other interferometer based sensor configurations, both measurement channel and reference channel can be first coated with Protein A or another protein or molecule that exhibits the similar functionality as Protein A, e.g. reduction of non-specific binding to the sensor surface, in this case in both the measurement channel and the reference channel, followed by coating with ‘clean’ serum sample (i.e. serum without specific analyte to be measured) or other (post-)blocking agents/solutions, consisting of one or a combination (simultaneous or sequential) of reference fluid(s), which are used to block non-specific binding sites. Commonly used blocking agents/solutions include, but without limitation, BSA (bovine serum albumin), serum, non-fat dry milk, casein, gelatin in PBS, etc. Next, the body fluid sample, e.g. serum containing specific analyte, can be applied in both channels (see schematic in FIG. 2.B). In this configuration, because both measurement and reference channels were initially fully coated with non-specific components being present in the ‘clean’ serum sample, addition of serum containing specific analyte may result mostly in sensor signal caused by the binding of the specific analyte to the antibody layer immobilized in the measurement channel, while additional non-specific signal caused by the binding of other components in the sample is expected to be negligible or much lower than specific binding because the most of the non-specific binding regions/sites are already occupied/blocked. As such, a lower non-specific signal, which is further compensated between the measurement channel and the reference channel, may therefore contribute in a more accurate signal corresponding to the specific binding.

In a further measuring scheme, a second reference channel, e.g. in a multichannel YI based sensor such as schematically depicted in FIG. 3, or any other interferometer configuration having at least 3 sensing channels, namely a measurement channel and two reference channels, which is pre-coated e.g. with Protein A, may be further coated with ‘clean’ serum sample (see schematic in FIG. 2.C). Coating with Protein A here may have the same purpose as it may have in the case of the measurement channel and reference channel, namely to reduce the non-specific binding to the sensor surface. The differential signal that may result between the reference channel and the second reference channel is largely due to temperature differences between these channels and other disturbing factors, resulting in the so-called drift. A difference in the temperature of the sample solutions, which are flowed in these channels, may also result in a temperature difference between them. Furthermore, a temperature difference can occur e.g. due to the binding event taking place in the measurement channel where heat exchange with the surrounding may occur. Because the signal due to the drift in the measurement channel occurs simultaneously with the signal due to the specific binding, during the time frame of a binding event it is practically impossible to discriminate between the sensor signal due to specific binding and the signal due to the drift. In this measuring scheme, the drift signal measured between the reference channel and the second reference channel may be used to correct/estimate the drift signal that occurs simultaneously between the measurement channel and the reference channel in addition to the specific signal in the measurement channel. This could be achieved e.g. by determining the relation between the signals for each pair of channels prior to application of the sample solution containing the specific analyte. By correcting/reducing the drift signal, this measuring scheme may result in a further improvement of the accuracy of the signal measured for the specific binding. This scheme could be possible if the interference signals between the measurement channel and two reference channels are acquired simultaneously or sequentially.

It is noted that in this embodiment, the sample—possibly containing the analyte—is preferably not brought into contact with the second reference channel, whereas this sample is preferably brought into contact with the first reference channel and with the measurement channel(s).

In a further measuring scheme, a third reference channel, e.g. in a multichannel YI based sensor, as schematically depicted in FIG. 3, which is pre-coated e.g. with Protein A, may be further coated with ‘clean’ serum sample (see schematic in FIG. 2.D). Coating with Protein A here has the same purpose as in the case of the measurement channel, reference channel and second reference channel, namely to reduce the non-specific binding to the sensor surface of these channels.

The differential signal that may result between the second reference channel and the third reference channel is mostly due to temperature differences between these channels and other disturbing factors, resulting in the so-called drift, whereas the differential signal between the reference channel and the second reference channel is due to temperature differences between these channels and other disturbing factors resulting in drift signal as well as some non-specific binding of the analyte at the sensor surface of the reference channel.

The differential signal that may result between the measurement channel and the reference channel is due to the specific binding of the analyte at the sensor surface of the measurement channel, drift signal between the measurement channel and the reference channel as well as the non-specific binding of the analyte at the sensor surface of the reference channel. Because the signal due to the drift between the measurement channel and the reference channel occurs simultaneously with the signal due to the specific binding in the measurement channel as well as the non-specific binding of the analyte in the reference channel, during the time frame of a binding event it is practically impossible to discriminate between the sensor signal due to specific binding in the measuring channel, the non-specific binding of the analyte in the reference channel and the signal due to the drift between the measurement channel and the reference channel. In this measuring scheme, the drift signal measured between the second reference channel and the third reference channel may be used to correct/estimate the drift signal that occurs simultaneously between the reference channel and the second reference channel as well as the drift signal that occurs between the measurement channel and the reference channel. This could be achieved e.g. by determining the relation between the signals for each pair of channels prior to application of the sample solution containing the specific analyte. By correcting/reducing the drift signal between the reference channel and the second reference channel, the non-specific binding of the analyte in the reference channel can be estimated. Furthermore, by correcting the drift signal between the measurement channel and the reference channel and estimating the non-specific binding of the analyte in the reference channel, this measuring scheme may result in even a further improvement of the accuracy of the signal measured for the specific binding of the analyte in the measurement channel. This scheme could be applied if the interference signals between the measurement channel and 3 reference channels are acquired, e.g. simultaneously or sequentially.

It is noted that in this scheme the sample, potentially containing the analyte to be detected, is preferably not brought into contact with the second and the third reference channel, whereas this sample will preferably be exposed to the first reference channel and the measurement channel(s).

In a similar fashion, the measuring schemes described above could be applied in a MMI (multimode interference) based interferometric sensor device with multiple sensing regions (ref. WO2010090514 and NL20092002491). In an MMI based sensor, light beam from a (monochromatic) light source, e.g. a laser, is coupled to an MMI coupler, in which the multimode interference structure may be arranged to allow propagation of different propagation modes. Along the propagation path, at least a measurement region and a reference region are provided (FIG. 5). Binding of analyte particles in the fluid with a specific receptor such as antibody, which is provided along the measurement region, can cause a change in propagation of at least one of the modes, and may provide for a change in the interference between the modes. As a result, a change in the light pattern as provided by the different modes onto the detector, which e.g. may be positioned at the endface of the multimode structure, may occur, hence allowing to detect a propagation characteristic by an analysis of the pattern provided onto the detector.

Each measurement region can be provided with a sensing window to allow application of fluid samples to be analyzed. To apply the first measuring scheme as described above, the sensing window of one of the sensing regions can be coated with a receptor layer such as an antibody layer using e.g. Protein A (measurement region). A Protein A coated sensor surface can be used to promote the binding and enhance proper orientation of the receptor for further analyte binding. Furthermore, coating the sensor surface with Protein A may result in reduction of non-specific binding to the sensor surface. An additional second (i.e. a reference) region may be coated only with Protein A. The body fluid sample, e.g. serum containing a specific analyte, e.g. a biomarker, can be applied (simultaneously) in both measurement and reference regions (see schematic in FIG. 2.A). Coating the sensor surface of the reference region with Protein A may also contribute to the reduction of the non-specific binding, in this case of the serum components, in analogy with the measurement region. Compared to the used measuring approach in which usually the sample is applied only in the measurement region, and therefore it is not possible to differentiate between the sensor signal caused by the specific binding of the analyte to the receptor layer immobilized on the sensor surface and the non-specific signal caused by the binding of other components in the sample solution to the sensor surface, this scheme provides the advantageous effect that the non-specific binding occurring in the reference region, which is also reduced by coating its sensor surface with Protein A in similar way as the measurement region, can largely compensate the non-specific binding that occurs simultaneously in the measurement region. Therefore the differential signal between the measurement region and the reference region is most probably caused by the specific binding of the analyte onto the antibody layer immobilized in the measurement region, considering a comparable non-specific binding of other components that are present in the sample in both measurement region and reference region.

In a further application of this measuring scheme in the MMI based interferometric sensor, both measurement and reference regions can be first coated with Protein A or another protein or molecule that exhibits the similar functionality as Protein A, e.g. reduction of non-specific binding to the sensor surface, in this case in both the measurement region and the reference region, then with ‘clean’ serum sample (serum without specific analyte to be measured) or other (post-)blocking agents/solutions, consisting of one or a combination (simultaneous or sequential) of reference fluid(s), which are used to block non-specific binding sites. Commonly used blocking agents/solutions include, but without limitation, BSA (bovine serum albumin), serum, non-fat dry milk, casein, gelatin in PBS, etc. Next, the body fluid sample, e.g. serum containing specific analyte, can be applied in both regions (see schematic in FIG. 2.B). In this configuration, because both measurement and reference regions were initially fully coated with non-specific components being present in the ‘clean’ serum sample, addition of serum containing specific analyte may result mostly in sensor signal caused by the binding of the specific analyte to the antibody layer immobilized in the measurement region, while additional non-specific signal caused by the binding of other components in the sample is expected to be negligible. As such, a lower non-specific signal, which is further compensated between the measurement region and the reference region, may therefore contribute in a more accurate signal corresponding to the specific binding.

In a further measuring scheme, a second reference region of the MMI based interferometric sensor, which is pre-coated e.g. with Protein A, may be further coated with ‘clean’ serum sample (see schematic in FIG. 2.C). Coating with Protein A here has the same purpose as in the case of the measurement region and reference region, namely to reduce the non-specific binding to the sensor surface. The differential signal that may result between the reference region and the second reference region is largely due to temperature differences between these regions and other disturbing factors, resulting in the so-called drift. A difference in the temperature of the sample solutions, which are flowed through these regions, may also result in a temperature difference between them. Furthermore, a temperature difference can occur e.g. due to the binding event taking place in the measurement region where heat exchange with the surrounding may occur. Because the signal due to the drift in the measurement region occurs simultaneously with the signal due to the specific binding, during the time frame of a binding event it is impossible to discriminate between the sensor signal due to specific binding and the signal due to the drift. In this measuring scheme, the drift signal measured between the reference region and the second reference region may be used to correct/estimate the drift signal that occurs simultaneously between the measurement region and the reference region in addition to the specific signal in the measurement region. This could be achieved e.g. by determining the relation between the signals for each pair of regions prior to application of the sample solution containing the specific analyte. Correction/reduction of the drift signal may result in a further improvement of the accuracy of the signal measured for the specific binding. This scheme could be possible if the interference signals between the measurement region and two reference regions are acquired, e.g. simultaneously or sequentially.

In a further measuring scheme, a third reference region RRG 3 as schematically depicted in FIG. 5, which is pre-coated e.g. with Protein A, may be further coated with ‘clean’ serum sample (see schematic in FIG. 2.D). Coating with Protein A here has the same purpose as in the case of the measurement region, reference region and second reference region, namely to reduce the non-specific binding to the sensor surface of these regions.

The differential signal that may result between the second reference region RRG 2 and the third reference region RRG 3 is mostly due to temperature differences between these regions and other disturbing factors, resulting in the so-called drift, whereas the differential signal between the reference region RRG and the second reference region RRG 2 is due to temperature differences between these regions and other disturbing factors resulting in drift signal as well as some non-specific binding of the analyte at the sensor surface of the reference region.

The differential signal that may result between the measurement region MRG and the reference region RRG is due to the specific binding of the analyte at the sensor surface of the measurement region, drift signal between the measurement region and the reference region as well as the non-specific binding of the analyte at the sensor surface of the reference region. Because the signal due to the drift between the measurement region and the reference region occurs simultaneously with the signal due to the specific binding in the measurement region as well as the non-specific binding of the analyte in the reference region, during the time frame of a binding event it is practically impossible to discriminate between the sensor signal due to specific binding in the measuring region, the non-specific binding of the analyte in the reference region and the signal due to the drift between the measurement region and the reference region. In this measuring scheme, the drift signal measured between the second reference region and the third reference region may be used to correct/estimate the drift signal that occurs simultaneously between the reference region and the second reference region as well as the drift signal that occurs between the measurement region and the reference region. This could be achieved e.g. by determining the relation between the signals for each pair of regions prior to application of the sample solution containing the specific analyte. By correcting/reducing the drift signal between the reference region and the second reference region, the non-specific binding of the analyte in the reference region can be estimated. Furthermore, by correcting the drift signal between the measurement region and the reference region and estimating the non-specific binding of the analyte in the reference region, this measuring scheme may result in even a further improvement of the accuracy of the signal measured for the specific binding of the analyte in the measurement region. This scheme could be applied if the interference signals between the measurement region and three reference regions are acquired, e.g. simultaneously or sequentially.

In a (bio-)sensor, the binding between the receptor such as antibody and the specific analyte is usually slow; it could take hours before complete saturation of the binding curve occurs. However, by analyzing the initial slope (˜ minutes) of the analyte binding curve, one can exactly determine the amount of analyte that has been present in the sample. As such one does not need to record the binding curve until it reaches full saturation in order to be able to determine how much analyte is present in the sample that is measured. In order to do so first one has to analyze for each receptor-analyte combination the slope of the binding curve. Next, the exact amount of analyte needs to be correlated to the slope of the binding curve such as to be able to exactly determine the quantity of the analyte that is present in the test sample. Furthermore, the software used for the analysis of the interference pattern must be tuned and pre-programmed for each set of analyte with its specific receptor that is at hand in the sensing window. In addition, the software can be adjusted to interpret the slope of the binding curve for the binding of an analyte to its specific receptor that is present in the sensing window.

Another advantage of all the schemes described above is that by applying the sample containing the specific analyte simultaneously in the measurement and reference regions/channels, the bulk refractive index signal, which is caused when different sample solutions, which have different refractive indices, are successively applied onto the sensor surface, can be compensated between these regions/channels. As a result, the slope of the analyte binding curve obtained during the first few minutes after the application of a sample onto the measurement region/channel is largely caused by the binding of the specific analyte to the antibody layer immobilized on the sensor surface of the measurement region/channel. Because the slope achieved during the first few minutes after a binding event is initiated is used to estimate the specific analyte concentration based on a pre-determined calibration curve, which can be obtained by determining the sensor signal for different specific analyte concentrations in the sample solution, then the compensation/reduction of the signal caused by the bulk refractive index may contribute to the further improvement of the accuracy of the sensor signal that is used for rapid estimation (˜ minutes) of the specific analyte concentration.

In an alternative measuring scheme, sensor surface of a measurement region is first coated with a receptor, which next to antibody, can be DNA string, enzyme, functional protein or other specifically analyte binding substance; later serum sample containing a specific analyte, e.g. a biomarker, is applied. Next, a dedicated solution, e.g. HCl acidic or ionic gradient solution, may be flowed to remove preferably only the specific analyte particles, but not the serum components that are non-specifically bound on the sensor surface. The signal change/decrease that is measured with respect to a reference region can correspond to the amount of analyte particles that are detached from the antibody layer (see FIG. 6.A). In a further application of this measuring scheme, the reference region can be coated with ‘clean’ serum sample (serum that does not contain the specific analyte to be measured).

Next, both measurement region and reference region can be simultaneously washed with a dedicated solution, e.g. HCl acidic or ionic gradient solution (see FIG. 6.B). The differential signal between these two regions may result in a more accurate signal corresponding to the amount of analyte particles that were initially specifically bound to and later detached from the antibody layer on the measurement region because the possible removal of the serum components from the measurement region might be compensated by simultaneous removal of the serum components from the reference region.

In analogy with the measuring scheme described above, as illustrated in FIG. 2.C, a second reference region may be coated with ‘clean’ serum (serum that does not contain the specific analyte to be measured) and washed simultaneously with the measurement region and other reference region with a dedicated solution such as HCl acidic solution. The differential signal between the reference region and the second reference region, which is largely caused due to the temperature changes between these regions and other disturbing factors (drift), may be further used to correct for the drift signal between the first (measurement) region and the reference region, hence it may improve further the accuracy of the signal corresponding to the specific binding in the measurement region, in complete analogy with the measuring scheme illustrated in FIG. 2.C.

The measuring schemes illustrated in and described with reference to FIG. 6 may be combined with the measuring schemes illustrated in and described with reference to FIG. 2. E.g. the measuring scheme illustrated in FIG. 2.C may be combined with measuring scheme illustrated in FIG. 6.C, as presented in FIG. 6.D, i.e. first sensor surface of a measurement region is coated with a receptor layer followed by coating of the measurement region, a reference region and a second reference region with ‘clean’ serum sample. Next, the sample containing the analyte is applied in the measurement region and the reference region. The sensor signal measured between the measurement region and the reference region is largely caused by the binding of the specific analyte to the antibody layer immobilized in the measurement region, while additional non-specific signal caused by the binding of other components in the sample is expected to be negligible or much lower than specific binding because most of the non-specific binding regions/sites are already occupied/blocked during coating with “clean” serum sample. The drift signal measured between the reference region and the second reference region may be used to correct/estimate the drift signal that occurs simultaneously between the measurement region and the reference region, which could be achieved e.g. by determining the relation between the signals for each pair of regions prior to application of the sample solution containing the specific analyte, potentially improving the accuracy of the signal corresponding to the specific binding in the measurement region.

Finally, the measurement region, the reference region and the second reference region can be washed simultaneously with a dedicated solution such as HCl acidic solution. The differential signal between the measurement region and the reference region may correspond to the amount of analyte particles that were initially specifically bound to and later detached from the antibody layer in the measurement region because the possible removal of the serum components from the measurement region might be compensated by simultaneous removal of the serum components from the reference region. The differential signal between the reference region and the second reference region, which is largely caused due to the temperature changes between these regions and other disturbing factors (drift), may be further used to correct for the drift signal between the measurement region and the reference region, hence it may improve further the accuracy of the signal corresponding to the specific binding in the measurement region.

In this combined measuring scheme, more (accurate) information can be obtained about the sensor signal corresponding to the binding of the specific analyte to the antibody layer immobilized in the measurement region, potentially leading to a higher specificity and sensitivity.

The aforementioned measuring schemes may be further combined with the use of multiple wavelengths and/or polarizations. For each wavelength/polarization, all the measuring schemes as described above in detail can be applied in the same way. Using more than one wavelength/polarization, in addition to the improvement of the accuracy of the signal that corresponds to the specific binding, by compensating/reducing the nonspecific binding contribution and other disturbing factors such as drift, the sensor signal that is measured for the specific binding of an analyte to the receptor layer immobilized onto the sensor surface of a measurement region/channel can be further improved. This new measuring scheme may be particularly useful for specific detection of relatively large analyte particles such as viruses, bacteria and cells in a complex medium such as body/animal/plant fluid (serum, plasma, blood, sputum, etc.), milk, waste streams, etc. Use of multiple wavelengths and/or polarizations could offer the possibility to better discriminate between the specific binding of large analyte particles such as viruses, bacteria and cells, and non-specific binding of the components that are present in the complex medium, e.g. proteins, DNA molecules, etc. For instance, using three different wavelengths, e.g. 488, 568 and 647 nm, because of the dispersion phenomenon, three different phase change signals between a measurement region/channel and a reference region/channel can be measured independently and (quasi-) simultaneously from each other. Consequently, a system of three independent equations can be obtained based on which three different contributions, e.g. specific binding of large analyte particles, non-specific binding of the other components present in the complex medium and bulk refractive index can be simultaneously determined. Simultaneous detection of non-specific binding of proteins and specific binding of viruses or bacteria is possible due to the difference in sensitivity coefficients towards proteins (˜10 nm), viruses (˜100 nm) and bacteria or cells (1000 nm) for different wavelengths. By subtracting/reducing further the contribution of the non-specific binding when more than one wavelength/polarization is used, the accuracy of the sensor signal measured for the specific binding will be further improved, potentially leading to an even higher specificity and sensitivity.

Furthermore, use of multiple wavelengths/polarizations could result in an increase of the signal-to-noise ratio (SNR) of the sensor signal because more information is achieved regarding binding events.

Use of additional wavelengths can allow estimation of other possible contributions, e.g. one of these contributions may be the temperature change that occurs during an immunoreaction or during a similar reaction with e.g. DNA/RNA or another receptor.

Integration with Light Scattering & Imaging of the Interference in the Chip

In addition to the application of measuring schemes as previously described and use of the multiple wavelengths/polarizations, light scattering from the sensing regions/windows on top of the optical waveguide chip OPC, as schematically shown in FIG. 8, may be simultaneously acquired and used to provide additional information regarding the specific binding events occurring in the sensing regions/channels in order to further improve the accuracy of the signal that corresponds to the specific binding. This embodiment may be employed in an MMI type interferometer configuration as well as in other interferometer configurations.

Upon binding of analyte particles on the sensing regions, the intensity of the scattered light from these regions will change, which further could give an indication about the amount of analyte particles bound on the sensing regions. Furthermore, discrimination based on the size of analyte particles such as proteins, viruses or bacteria could be possible because the scattering signal depends on the particle size and optical properties such as refractive index. This information could be used e.g. to better discriminate between the specific binding of large analyte particles such as viruses, bacteria and cells, and non-specific binding of proteins that could be present in a body fluid sample that is being analyzed, in addition to the discrimination/estimation that is achieved using previously measuring schemes and multiple wavelengths/polarizations. In order to detect the scattering, a mirror MIR or other suitable optics, may be positioned above respectively under the optical chip OPC, so as to direct at least a part of the scattered light onto (e.g. a part of) the detector CCD.

Furthermore, the intensity distribution of the interference pattern, e.g. between different excited modes in the multimode structure of a MMI based sensor could be used as extra additional information to monitor binding events occurring on the sensing regions on top of the MMI multimode structure. Upon binding of a specific analyte onto a given sensing region, the intensity distribution will be locally changed. As this change depends on the analyte concentration, imaging of the intensity distribution in the MMI multimode structure could allow on-line monitoring of this intensity change and consequently may enable estimation of the analyte concentration.

Combining the signals obtained from the analysis of the interference pattern, light scattering from analyte particles and imaging of the interference in the chip could provide more accurate information about the specific analyte-receptor interactions by reducing/correcting non-specific bindings and/or other disturbing factors such as temperature changes, which may lead to higher specificity, accuracy and sensitivity of the sensor. Also, this scheme may provide a higher SNR of the sensor signal because more information about the binding events is achieved.

In each one of the embodiments described in this document, next to or instead of liquid samples, vapours and gas samples (e.g. air) could be analyzed, e.g. when the gas is pre-treated, concentrated and diluted into a liquid, e.g. PBS buffer. This could be useful e.g. for detection of airborne pathogenic micro-organisms such as viruses and bacteria in hospitals, emergency clinics, etc. A pre-concentration step may be necessary to increase the concentration in a given volume to detectable values as well as to obtain statistically relevant data. A pre-concentration step could also be applied to liquid samples when large volumes need to be analyzed, e.g. water, beer, etc.

Gasses could also be detected by using gas absorbent layers that are specific towards a given gas component, e.g. CO2, toxic gasses, etc.

Solid samples could also be analyzed when these samples are diluted/suspended into a liquid, e.g. PBS buffer.

The (bio-)sensor device comprises a (portable) measurement system POD and a lab-on-a-chip (LOC) system. The LOC, an embodiment of which being depicted in FIG. 10A, comprises an inlet INL, a fluid supply (in this example comprising a (micro-)fluidic cuvette FCV), a sensing part SRG comprising the measurement and reference regions and in most instances completed by an outlet OTL for disposing the fluid or disposing air or other gas as a result of a supply of the sample into the sensing part. The (micro-)fluidic part may also in part or in full be comprised in the portable measurement system. The measurement region and/or reference region(s) can be pre-coated with specific receptor molecules, such as antibodies, DNA strings, enzymes, functional proteins or other specifically analyte binding substances in order to make the chip selective for one particular analyte. Pre-coating can be performed well in advance of actual measurements and pre-coated chips can be packed and shipped, but pre-coating can also just precede the actual measurement whereas the sensor device can offer the means (flowing fluids) to coat the chip. Hence, a function of “chip loader” could also be accomplished by the portable measurement system. The working principle of the portable (bio-) measurement system is schematically presented in FIG. 9: First the sample (highly schematically indicated by SAM in FIG. 9) to be analyzed is delivered to the inlet of the lab-on-a-chip system. Certain samples can be diluted, e.g. with buffer (that may be pre-packed within the chip), e.g. PBS, to improve the sample flow towards the sensing regions/windows of the (bio-)sensor (1). The sample will flow from the (LOC) inlet to the sensing regions/windows via (micro-)fluidic channels. This could be achieved e.g. by using a (micro-) fluidic channel configuration that provides capillary forces or using a micro-pump to push the fluid from the LOC inlet towards sensing regions. (Micro)-fluidic channel configuration, e.g. height, width, etc., could be varied such as to create different binding kinetics of various components (e.g. specific analytes and non-specific components that may be present in the fluid sample solution) in the sensing regions/windows. The difference in binding kinetics between specific analytes and non-specific components in (micro-)fluidic channels with different configurations (which may be estimated for a given configuration) may allow to further discriminate between the specific analyte binding and non-specific binding of other components. Furthermore, the flow speed could be varied, e.g. creating different flow speeds in different (micro-)fluidic channels, to allow an additional difference in binding kinetics between specific analytes and non-specific components upon application of the fluid sample solution and/or the reference fluid and/or the blocking fluid or other fluid into the sensing regions/windows.

Upon insertion of the LOC system into the portable measurement system (2), a measurement will be (automatically) started and the analyte binding will be recorded. Analysis of the binding curve in the first few minutes will provide the analyte concentration whereas the receptor layer pre-coated into the chip yields information about the type of analyte detected. Examples of analytes include, but without limitation, biomarkers, DNA molecules, viruses, bacteria, cells, etc. (3). Next to diagnosis applications, this measuring scheme may be preferable for screening purposes as well, e.g. in airports, emergency clinics or infected areas, where a rapid response is especially important.

The lab-on-a-chip system may also be used for continuous sample monitoring purposes. In this case the sample can be flowed over the LOC through the sensing regions/windows of the (bio-)sensor for a given time period. This measuring scheme may be useful when a sample, which e.g. is collected from a processing or production unit, has to be monitored continuously, possibly in line, for the presence of certain analytes, e.g. pesticides in (drinking/waste) water, antibodies in milk or yeast in beer. A (continuous or not) pre-treatment (e.g. concentration, mixing, etc.) step may precede the actual measurement.

In a preferable configuration, the lab-on-a-chip system can be held by a chip holder CPH, which e.g. could be made of a plastic material, e.g. Delrin, on top of which the optical waveguide chip resides. The latter (the optical waveguide chip) can be made of e.g. Silicon or other suitable optical materials. The (micro-)fluidic part of the LOC can e.g. be made of PDMS (Polydimethylsiloxane), PMMA (Polymethylmethacrylaat) or another biocompatible material. All these LOC parts can be integrated into one chip system (see FIG. 10). Integration of the (micro-)fluidic part into the LOC system can be preferable e.g. for minimization of the sample leakage that may occur when the sample is flowed through the sensing regions/windows of the optical chip. Minimization of the sample leakage is further preferable to prevent contamination of the LOC system and contamination of the portable measurement system in which the LOC is read-out, which may further result in an improvement of the operator safety. In this configuration, the size of the optical waveguide chip can be kept as small as possible, which may contribute in minimization of the costs per test, without deteriorating the sensing performance such as sensitivity and stability as well as the multiplexing capability, which means that also in this miniaturized chip layout there may be multiple measurement regions. In other words, one LOC can have multiple sensing regions/windows and can thus detect simultaneously (various) multiple analytes (e.g. for panel testing purposes). Each measurement region can be coupled to one or more reference regions, e.g. to allow application of the measurement schemes as described previously. Alternatively, one reference region can also be coupled to one or more measurement regions. Minimal costs are necessary in order to offer the LOC as a one-off disposable, but the LOC can also be designed such that it can be re-usable (see below).

The holder may be designed such that, upon positioning of the (micro-)fluidic cuvette on top of the optical chip (see a schematic example of each component of the LOC system and the integrated system in FIG. 10.B), the fluidic channels of the cuvette are properly aligned with respect to the sensing regions/windows that are realized on the optical chip. To do so, the holder can be etched or otherwise configured in such a way that the (micro-)fluidic cuvette can be positioned on it as shown in FIG. 10.B. The optical chip can be positioned at the bottom of the etched structure of the (plastic) holder, e.g. by etching a channel that is slightly wider than the optical chip. In that way, lateral positioning of the optical chip can be obtained. The positioning along the other direction, which may be less critical, can be arranged with respect to the endface of the (plastic) holder. After alignment of the optical chip at the bottom of the etched structure is achieved, the (micro-)fluidic cuvette can be inserted in this structure by pushing it down from the top of the structure until it comes in contact with the optical chip, aligning it with respect to the holder. Details on a possible fibre-to-chip coupling are provided below. Because the optical chip is aligned with respect to the (plastic) holder and also the (micro-)fluidic cuvette is aligned with respect to the holder, then the (micro-)fluidic cuvette will be automatically aligned with respect to the optical chip. As a result, the fluidic channels of the cuvette will be aligned with respect to the sensing regions/windows of the optical chip.

Once aligned with respect to the (plastic) holder, the optical chip could also be permanently positioned on it using e.g. a bonding technique.

The lab-on-a-chip system can be built such that it may be interchangeable. The fluidic connection with the LOC system may be arranged such as to allow a fast interchangeability, e.g. it may be configured as a modular unit, that can be quickly positioned upon inserting of the lab-on-a-chip system into the portable measurement system, in that way enabling performance of a rapid test measurement. This configuration may be preferable in combination with an auto-alignment method to enable a faster and better coupling of the (laser) light beam into the optical waveguide chip after insertion of the system into the portable measurement system. Furthermore, receptor layers used to pre-coat the chip can be better preserved in such an integrated, closed system. Such a closed system may protect the receptors such as antibodies from (fast) deteriorating and may also prevent contamination of the sensing regions/windows after pre-coating process and prior to application of analyte samples.

The interchangeable lab-on-a-chip system may be disposable, implying use of a new system for each sample that has to be measured, which may be preferable e.g. for safety reasons, when a sample containing an infectious pathogen such as virus needs to be analyzed. In a disposable LOC system, the sample that is first delivered to the LOC inlet can be further flowed to the sensing regions/windows e.g. by using a (micro-)fluidic channel configuration that provides capillary forces. This configuration is preferable when a sample containing an infectious pathogen needs to be analyzed because the part of the flow system that is used to bring the sample from an external reservoir to the sensing regions/windows, e.g. tubes, connectors, etc., will not be contaminated.

The LOC system may also be re-usable, e.g. using a regeneration procedure in which only the bound analyte particles are removed using a dedicated solution, e.g. HCl acidic or ionic gradient solution, or when both the antibody layer and analyte are completely removed from the sensor surface using a given cleaning procedure, e.g. washing with a strong acidic solution such as 100% HNO₃.

In the measurement system, different components of the (optical) set-up, which are used to read-out the LOC system, such as the light source, e.g. a laser diode; incoupling optics, e.g. polarizer, lenses, feedback system for automated light coupling into the optical chip, e.g. a piezo system, and/or a fibre-to-chip coupling system; chip holder; fluid supply, whether or not coupled to a (micro-)fluidic pump, to add fluid to the sensing regions/windows of specific chip channels; a detector, e.g. a CCD camera (including components used to obtain an optimal outcoupling of the light from the optical chip to the CCD array chip, such as lenses, filters or matching oil that could be used when the CCD chip can be mounted onto the optical chip endface), single board computer, touchscreen, electronic circuit and power supply can be integrated into the measurement system (see FIG. 11). A computer board, which may be used for data collection and analysis, is an inexpensive solution that can perform overall sensor device control. In another configuration, a personal digital assistant (PDA) may also be used to perform the device operation, which may result in a more compact measurement system e.g. having lower power consumption. The measurement system can be battery-operated to enable stand-alone operation. In the embodiment depicted in FIG. 11, a fluid supply system with pump and valves may be provided as a separate module, whereby the (micro-)fluidic part may be integrated on the chip or at least partially on or in the measurement system. In this embodiment, each channel is individually and specifically addressed.

This closed configuration of the measurement system may be preferable to prevent or reduce different disturbing factors such as background light sources as well as temperature and humidity variations caused by the external environment. Furthermore, a compact, portable measurement system is potentially very useful for on-site field applications as well as in remote or developing regions without easy access to sophisticated laboratory facilities. In this document, the terms measurement region, measurement channel, measurement window, sensing window, and sensing region should be understood so as to refer to same or similar items. Similarly, the terms reference region, reference channel, and reference window should be understood so as to refer to the same or similar items. Also, the terms waveguide structure, planar structure, optical chip and lab-on-a-chip may be considered to refer to same or similar items.

It is remarked that next to the signal of the light scattered from the analyte particles, the signal obtained from the specific labelling, e.g. fluorescent, magnetic, etc., of the analyte particles can be acquired in similar fashion using a dedicated optical scheme. The signal due to specific labelling could provide additional information about the sensor signal corresponding to the specific binding of the analyte, hence improving even further the accuracy and the sensitivity of the sensor.

Further, it is remarked that an antigen can also play the role of the receptor to detect e.g. the presence of an antibody in a given sample solution. This could be achieved by coating the sensor surface with an antigen layer and applying the sample solution containing the antibody to the antigen-coated sensor surface.

Still further, it is remarked that the use of a white-light supercontinuum source may enable a high resolution discrimination between the sensor signal caused by the changes, e.g. in refractive index, etc, in the region within a few nanometres from the sensor surface and the signal caused by the changes taking place in the region between a few nanometres to e.g. hundred of nanometres from the sensor surface. This could be preferable to obtain more accurate information about processes that may occur in close vicinity with the sensor surface such as conformational changes in biomolecules, protein aggregations, etc.

Still even further, the disclosed method and the measurement system, next to detection of an analyte in a fluid sample, could also be used for quantitative measurement of affinities and kinetics of various biomolecular interactions such as protein-protein, protein-DNA, receptor-ligand, etc.

FIG. 12A depicts the sensor signal Ss (i.e. phase signal) on the y-axis versus time T on the x-axis, based on which an effect of embodiments according to the invention will be illustrated. The sensor signal comprises a differential signal that expresses a difference between the measurement region and the reference region over time. Each depicted curve represents a differential signal between the measurement channel and the reference channel. The measurement channel is provided with the receptor. It is noted that the phase signal represents a phase of a spatial frequency peak in the fast fourier transform of the interference pattern, as explained above.

The improvement of the sensor signal stability in an interferometric sensor when both the measurement channel and the reference channel are coated with the blocking fluid, in accordance with an embodiment of the invention, is illustrated in FIGS. 12A and B with data obtained from experimental measurements. In this figure, the differential signal measured between the measurement channel and the reference channel during the measurement of a sample fluid, is presented. FIG. 12A presents the measurement of the complete binding curve; FIG. 12B is a close view of the sensor signal baseline before and immediately after application of the sample fluid in the measurement channel. Curve B indicates the differential signal measured between the measurement channel and the reference channel when both the measurement channel and the reference channel are coated with the blocking fluid. Curve A indicates the differential signal measured between the measurement channel and the reference channel when only the measurement channel is provided with the blocking fluid. The sample is applied at Ta (for example to replace blocking fluid, reference fluid or other fluid), washing is performed at Tw.

As it can be clearly seen from this figure, the differential signal measured when both the measurement channel and the reference channel are provided with the blocking fluid (curve B) is much more stable compared to the differential signal when only the measurement channel is provided with the blocking fluid (curve A). Therefore, the differential signal corresponding to the specific binding, which is determined by comparing the signal baselines before application of the analyte sample at Ta and after washing step at Tw, can be estimated with a higher accuracy when both the measurement channel and the reference channel are provided with the blocking fluid, resulting further in a higher sensitivity. Thus, a characteristic of the (reference) optical pattern obtained before application of the sample is compared with the characteristic of the optical pattern obtained during and/or after providing of the sample.

In accordance with a further embodiment of the invention, the sample fluid is applied on both the measurement channel and the reference channel after providing both channels with the Blocking Fluid; this is depicted in curve C.

If the sample fluid will be provided not only into the measurement channel, but also into the reference channel, which both were previously coated with the blocking fluid, then next to a more stable differential signal, as illustrated above, there may be also a reduction/compensation of the bulk effect (in FIG. 12A referred to as Delta 2 while an effect of the binding of the analyte is referred to as Delta 1) between the sample fluid and the blocking fluid. This may result in a more accurate estimation of the initial slope of the binding curve, which may be used to derive the presence of the analyte during the very first minutes after application of the sample fluid.

In FIG. 12A the differential signal measured between the measurement channel and the reference channel when the sample fluid is provided to both channels (after both channels were coated with blocking fluid before) is depicted as curve C

FIG. 12A depicts a measurement of a complete binding curve. As expected, a binding slope measured when the sample fluid is provided into both the measurement channel and the reference channel (curve C) is corrected for a bulk effect between the blocking fluid and the sample fluid (curve B), which is present when the sample fluid is provided only into the measurement channel.

Furthermore, when the sample fluid will be provided into both the measurement channel and the reference channel, the additional non-specific binding that may be caused by sample fluid components other than specific analyte binding may be compensated between the measurement channel and the reference channel, contributing therefore to a more accurate differential signal corresponding (almost) one-to-one to the specific binding of the analyte of interest.

FIG. 12B depicts an enlarged, detailed view of an initial binding slope SL when:
only the measurement channel is provided with the blocking fluid and the sample fluid is applied only to the measurement channel (curve A);
both the measurement channel and the reference channel are provided with the blocking fluid and the sample fluid is applied either only in the measurement channel (curve B) or in both the measurement and the reference channel (curve C).

In this FIG. 12B, curve A has been shifted upwards along the y-axis (compared to FIG. 12A), for a better comparison with the two other curves B and C.

When only the measurement channel is provided with the blocking fluid and the sample is applied only in the measurement channel (curve A), next to a bigger slope (compared to curve C), due to the bulk effect between the blocking fluid and the sample fluid (being also present in curve B), there is also an unstable signal, which e.g. can be caused by the temperature drift, that deteriorates the accuracy of determining the binding slope that corresponds to the specific binding, which further can result in a lower sensitivity.

Detection limit in accordance with the invention, as achieved so far experimentally, is ˜1 fg/ml for an average mid-sized protein S100β, which considering a penetration depth of evanescent field of ˜200 nm, is equivalent to ˜10⁻³ fg/mm². It should be noted that the sensitivity of the method is still one order of magnitude above the noise level. This means that when the signal to noise ratio is improved with image analysis algorithms, the sensitivity will be even higher.

1. A method for detecting an analyte in a fluid sample, comprising:
a) providing a measurement region and a reference region, the measurement region being provided with a receptor for binding the analyte;
b) providing at least one light beam so as to travel along the measurement region and along the reference region;
c) providing the fluid sample into at least the measurement region;
d) detecting by means of a detector an optical pattern provided by the at least one light beam after having travelled along the measurement region and the reference region; and
e) deriving a presence of the analyte in the fluid sample from the detected optical pattern, wherein prior to c) a blocking fluid is provided along the measurement region and along the reference region.

2. The method according to claim 1, wherein the fluid sample is provided into the measurement region and the reference region.

3. The method according to claim 1, comprising:
detecting before c) by means of the detector a reference optical pattern provided by the at least one light beam after having travelled along the measurement region and the reference region,
wherein d) is performed at least once during or after providing of the fluid sample into at least the measurement region,
and wherein e) comprises:
comparing a characteristic of the reference optical pattern with the characteristic of the optical pattern detected in d), and obtaining the presence of the analyte therefrom.

4. The method according to claim 3, wherein the characteristic of the optical pattern and the reference optical pattern comprises a phase of a frequency component in a spatial frequency spectrum of the optical pattern, the frequency component from an interference between the at least one light beam having travelled along the measurement region and having travelled along the reference region.

5. The method according to claim 1,
wherein a second reference region is provided,
wherein d) further comprises measuring a deviation between the reference region and the second reference region, and
wherein e) further comprises estimating a disturbance from the deviation measured in d) between the reference region and the second reference region, and correcting the information concerning the presence of the analyte for the estimated disturbance.

6. The method according to claim 5, wherein c) further comprises providing a reference fluid at least along the second reference region.

7. The method according to claim 5, wherein the disturbance comprises a drift between the measurement region and the reference region,
wherein prior to c) a first drift is measured between the measurement region and the reference region and a second drift is measured between the reference region and the second reference region, wherein a drift relation is determined between the first drift and the second drift, and
wherein the drift between the measurement region and the reference region is estimated from the determined drift relation and the deviation as measured in d) between the reference region and the second reference region.

8. The method according to claim 5, wherein a third reference region is provided,
wherein d) further comprises measuring a deviation between the second reference region and the third reference region, and
wherein e) further comprises estimating a further disturbance from the deviation measured in d) between the second reference region and the third reference region, and correcting the deviation between the reference region and the second reference region for the estimated disturbance.

9. The method according to claim 8, wherein the further disturbance comprises an effect of non-specific binding.

10. The method according to claim 8, wherein a fourth reference region is provided,
wherein d) further comprises measuring a deviation between the third reference region and the fourth reference region, and
wherein e) further comprises estimating a still further disturbance from the deviation measured in d) between the third reference region and the fourth reference region, and correcting the deviation between the reference region and the second reference region and between the second reference region and the third reference region for the estimated disturbance.

11. The method according to claim 10, wherein the still further disturbance comprises a bulk effect between the sample solution and the blocking and/or reference fluid.

12. The method according claim 1, wherein
e) comprises determining an initial slope of a measurement curve and deriving the presence of the analyte from the determined initial slope.

13. The method according to claim 12, wherein the initial slope of the measurement curve is compared to pre-determined calibration data relating the initial slope to different analyte concentrations.

14. The method according to claim 1, comprising the further steps of: removing at least part of the analyte from the receptor layer by a removal process, the optical pattern being detected before and after the removal.

15. The method according to claim 14, wherein a reference fluid is applied along the reference region and wherein the removal process is further performed along the reference region.

16. The method according to claim 15, wherein the reference fluid is further applied along the second reference region, wherein the removal process is further performed along the second reference region, and wherein e) comprises deriving a drift between the measurement region and the reference region from a drift measured between the reference region and the second reference region, and correcting the information concerning the presence of the analyte for the derived drift between the measurement region and the reference region.

17. The method according to claim 1, wherein the light beam comprises at least two spectrally distinct wavelength ranges, the detection being performed for each of the wavelength ranges.

18. The method according to claim 17, wherein three distinct wavelength ranges are comprised in the light beam, e) comprising determining analyte binding, non-specific binding and bulk refractive index from the detected optical patterns for each of the wavelengths.

19. The method according to claim 1, wherein the light beam comprises a supercontinuum wavelength range, e) preferably comprising a monitoring process occurring in close vicinity, with, preferably a nanometer distance from a sensor surface of at least the measurement region.

20. The method according to claim 1, wherein at least d) is repeated making use of a different state of polarization of the light beam, the detection being performed for each state of polarization.

21. The method according to claim 1, further comprising:
detecting a scattering of light from the measurement region and the reference region, and combining the detected light scattering with the detected optical pattern in order to derive the presence of the analyte in e).

22. The method according to claim 1, further comprising:
detecting a spatial intensity distribution of the light travelling through the measurement and reference regions, and combining the detected local intensity distributions with the detected optical pattern, in order to derive the presence of the analyte in e).

23. The method according to claim 1, wherein the measurement region and the reference region are provided on or in a planar structure.

24. The method according to claim 23, wherein the fluid sample and/or the reference fluid and/or the blocking fluid or other fluid is provided into at least one of the measurement region and the reference region by a fluid supply, the method comprising holding the planar structure and the fluid supply by a holder and aligning the fluid supply to at least the measurement region by the holder.

25. The method according to claim 1, wherein at least two measurement regions are provided, each being provided with a respective receptor for binding a respective analyte.

26. A measurement system for detecting an analyte in a fluid sample, comprising:
a measurement region and a reference region, the measurement region being provided with a receptor for binding the analyte;
a light source for generating at least one light beam a light guiding means for guiding the light beam along the measurement region and along the reference region;
a fluid supply for providing the fluid sample and/or the reference fluid and/or the blocking fluid or other fluid into the measurement region and/or the reference region;
a detector for detecting an optical pattern provided by the at least one light beam after having travelled along the measurement region and the reference region; and
a data processing device for deriving a presence of the analyte in the fluid sample from the detected optical pattern.

27. The measurement system according to claim 26, wherein at least the measurement region and the reference region are provided on a chip structure, the measurement system comprising a holder that holds the chip structure and the fluid supply, the holder aligning the fluid supply to the measurement and reference regions.

28. A disposable measurement structure comprising:
a chip structure comprising a measurement region and a reference region;
a light guiding means for guiding a light beam along the measurement and reference regions;
a fluid supply for guiding a fluid sample into the measurement region and the reference region; and
a holder for holding the chip structure and the fluid supply, the holder aligning the fluid supply to the measurement and reference regions.
